(19) United States
(12) Patent Application Publication
(10) Pub. No.: US 2022/0032241 A1
(43) Pub. Date: Feb. 3, 2022

(54) METHODS OF PREPARING DUAL-LAYER POLYVINYLIDENE FLUORIDE HOLLOW FIBER MEMBRANES AND USES THEREOF

(71) Applicant: New Mexico Tech University Research Park Corporation, Socorro, NM (US)

(72) Inventors: Jianjia YU, Socorro, NM (US); Lusi Zou, Socorro, NM (US); Pri GUSNAWAN, Socorro, NM (US); Guoyin ZHANG, Socorro, NM (US); Robert BALCH, Socorro, NM (US)

(21) Appl. No.: 17/377,844

(22) Filed: Jul. 16, 2021

Related U.S. Application Data
(60) Provisional application No. 63/053,256, filed on Jul. 17, 2020.

(51) Int. Cl. B01D 71/34; B01D 69/08; B01D 69/02; C02F 1/44

(52) U.S. Cl. CPC B01D 71/34; B01D 69/08; B01D 69/02; C02F 2101/10; B01D 2325/02; B01D 2325/04; B01D 2325/38; C02F 1/44

(57) ABSTRACT

Disclosed herein are compositions, systems, and methods of using dual-layer hollow fiber membranes. The compositions and systems of the disclosure can be used to desalinate water from an underground formation. The compositions and systems of the disclosure can be further used to capture carbon dioxide from a gaseous sample.

### CROSS-REFERENCE

This application claims the benefit of U.S. Provisional Application No. 63/053,256, filed Jul. 17, 2020, which application is incorporated herein by reference in its entirety.

### GOVERNMENT RIGHTS

This invention was made with the support of the United States government under Contract number R17AC00143 by the United States Bureau of Reclamation. The government has certain rights in the invention.

### BACKGROUND

Hollow fiber membranes (HFMs) are a class of artificial membranes containing a semi-permeable barrier in the form of a hollow fiber. HFMs can be used in water treatment, desalination, cell culture, medicine, or tissue engineering. The properties of the membrane can be finely tuned by changing processes and compositions of the materials used to produce the membranes.

### INCORPORATION BY REFERENCE

All publications, patents, and patent applications mentioned in this specification are herein incorporated by reference t/o the same extent as if each individual publication, patent, or patent application was specifically and individually indicated to be incorporated by reference.

### SUMMARY OF THE INVENTION

In some embodiments, disclosed herein is a composition comprising a fiber, wherein the fiber comprises: a) an inner layer, wherein the inner layer comprises a fluoropolymer, wherein the inner layer has a tubular shape, wherein the inner layer further comprises an inner surface and an outer surface; and b) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber.

In some embodiments, disclosed herein is a system comprising a plurality of independent fibers, wherein each fiber is independently in fluid communication with a common fluid manifold, wherein each fiber independently comprises: a) an inner layer, wherein the inner layer comprises a fluoropolymer, wherein the inner layer has a tubular shape, wherein the inner layer further comprises an inner surface and an outer surface; and b) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber, wherein each fiber is independently configured to remove an impurity from a fluid sample as the fluid sample passes through the fiber from the common fluid manifold.

In some embodiments, disclosed herein is a method comprising contacting a fluid sample with a fiber, wherein the fiber comprises: a) an inner layer, wherein the inner layer comprises a fluoropolymer, wherein the inner layer has a tubular shape, wherein the inner layer further comprises an inner surface and an outer surface; and b) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber.

In some embodiments, disclosed herein is a method of making a fiber, the method comprising co-extruding a first dope mixture and a second dope mixture, wherein: a) the first dope mixture comprises a first fluoropolymer, polyethylene glycol (PEG), and a solvent; and b) the second dope mixture comprises a second fluoropolymer and a crosslinking agent, wherein the fiber comprises: i) an inner layer, wherein the inner layer comprises a fluoropolymer, wherein the inner layer has a tubular shape, wherein the inner layer further comprises an inner surface and an outer surface; and ii) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber.

### BRIEF DESCRIPTION OF THE DRAWINGS

FIG. 1 shows the interconnected pore-structure of a HFM.

FIG. 2 illustrates the apparatus used to measure desalination performance and anti-wetting behavior of the HFMs.

FIG. 3 illustrates a schematic drawing of a PVDF DCMD HFM.

FIG. 4 PANEL A shows PVDF/Si-R HFMs. PANEL B shows PVDF/Si-R HFM bundles. PANEL C and PANEL D show cross-sectional SEM images of the PVDF/Si-R HFMs. PANEL E shows an example commercial stack.

FIG. 5 shows the cross-sectional morphology of the PES/PVDF/Si-R dual-layer HFM.

FIG. 6 PANEL A shows the CO₂ desorption efficiency of the soybean-based (SBB) solvent. PANEL B shows the CO₂ desorption rate of the SBB solvent.

FIG. 7 illustrates the dual-layer J-HFM and the J-HFM contactor process using a SBB solvent as the CO₂ absorbent.

FIG. 8 shows the rheological properties of the 12 wt % PVDF dope solutions prepared with different additives.

FIG. 9 shows an endothermic peak from the dope solution D-N2H2-9 on the DSC heating curve, and that the melting peak was located at 52.3° C.

FIG. 10 illustrates the apparatus that was used to measure the liquid entry pressure of the hollow fiber membranes.

FIG. 11 illustrates the apparatus that was used for the DCMD experiments.

FIG. 12 PANEL (a) shows the water contact angles of the membranes prepared with different ammonia and water concentrations. PANEL (b) shows the water contact angle of the flat-sheet membrane PVDF/PEG-6000.

FIG. 13 shows the color changes of the PVDF dope solution upon dehydrofluorination.

FIG. 14 PANEL (a)-PANEL (e) show the chemical compositions on the membrane surface as examined by XPS.

FIG. 15 shows the cross-sectional morphologies of the HFMs SP, DH4, DN2H2, and DN2H2-9.

FIG. 16 illustrates the outer surface morphologies of the membranes DN2H2 and DN2H2-9.

FIG. 17 shows the crystallization behaviors of the dual-layer HFMs.

FIG. 18 shows the mechanical properties of the hollow fiber membranes. PANEL (a) shows strain-stress curves, and PANEL (b) shows tensile stress and Young's moduli.

FIG. 19 shows DCMD performances of the hollow fiber membranes in terms of PANEL (a) permeate water flux; and PANEL (b) energy efficiency.

FIG. 20 PANEL (a) shows the effect of feed solution velocity (V_{f}) on water flux. PANEL (b) shows the effect of permeate water velocity (Vₚ) on water flux. PANEL (c) illustrates the effect of feed salinity on the DCMD performance of the hydrophilic-hydrophobic dual-layer hollow fiber membrane DN2H2-9.

FIG. 21 shows water flux and permeate conductivity of the DN2H2-9 during 200 h of continuous desalination operation with a 3.5 wt % NaCl as a feed solution.

FIG. 22 shows water flux and rejection of the dual-layer HFM DN2H2-9 for desalination of real oilfield-produced water.

FIG. 23 shows ATR-FTIR spectra of fresh, used, and regenerated membrane DN2H2-9.

### DETAILED DESCRIPTION OF THE INVENTION

Hollow fiber membranes (HFMs) are a class of artificial membranes containing a semi-permeable barrier in the form of a hollow fiber. HFMs can be used in water treatment, desalination, cell culture, medicine, or tissue engineering. Most commercial HFMs are packed into cartridges that can be used for liquid and gaseous separations.

HFMs are commonly produced using artificial polymers. The production of specific HFMs is heavily dependent on the type of polymers used and the molecular weight of the polymers. HFM production, commonly referred to as “spinning”, can be divided into four general types: 1) melt spinning, in which a thermoplastic polymer is melted and extruded through a spinneret into air and subsequently cooled; 2) dry spinning, in which a polymer is dissolved in an appropriate solvent and extruded through a spinneret into air; 3) dry-jet wet spinning, in which a polymer is dissolved in an appropriate solvent and extruded into air and a subsequent coagulant; and 4) wet spinning, in which a polymer is dissolved and extruded directly into a coagulant. In some embodiments, the coagulant is water.

A spinneret is a device containing a needle through which a solvent is extruded, and the spinneret further comprises an annulus through which a polymer solution is extruded. As the polymer is extruded through the annulus of the spinneret, the polymer retains a hollow cylindrical shape. As the polymer exits the spinneret, the polymer solidifies into a membrane through a process known as phase inversion. The properties of the membrane, such as average pore diameter and membrane thickness, can be finely tuned by changing the dimensions of the spinneret, temperature and composition of the dope (polymer) and bore (solvent) solutions, length of air gap (for dry-jet wet spinning), temperature and composition of the coagulant, and the speed at which produced fiber is collected by a motorized spool. Extrusion of the polymer and solvent through the spinneret can be accomplished by gas-extrusion or a metered pump.

Disclosed herein are single and dual-layer crosslinked polyvinylidene fluoride (PVDF) HFMs and methods of producing crosslinked PVDF HFMs. The HFMs of the disclosure have large surface areas per unit volume, self-mechanical support, and high-flexibility. In some embodiments, the HFMs of the disclosure can be used in a membrane contactor process. The dual-layer HFMs of the disclosure provide the flexibility of using two different polymer solutions. In some embodiments, the dual-layer HFMs of the disclosure comprise a thick, porous CO₂-philic inner layer and a thin super-hydrophobic outer layer. In some embodiments, the CO₂-philicity and super-hydrophobicity of the dual-layer HFMs disclosed herein can be achieved by integrating a CO₂-philic polymer. In some embodiments, the CO₂-philic polymer is poly(ethylene glycol) (PEG) with semi-crystalline PVDF.

### Dual-Layer Hollow Fiber Membranes

Disclosed herein are hollow fiber membranes with an inner layer and an outer layer. In some embodiments, disclosed herein is composition comprising a fiber, wherein the fiber comprises: a) an inner layer, wherein the inner layer comprises a fluoropolymer, wherein the inner layer has a tubular shape, wherein the inner layer further comprises an inner surface and an outer surface; and b) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber. In some embodiments, the fiber further comprises a first end and a second end, wherein the first end is an inlet and the second end is an outlet, wherein the inlet is configured to allow passage of a fluid into the tubular channel, and the outlet is configured to allow passage of the fluid out of the tubular channel.

In some embodiments, a composition, fiber, or membrane of the disclosure can be a tubular shape. In some embodiments, the composition, fiber, or membrane of the disclosure can be a tubular shape, wherein the length of the tubular shape is greater than the cross-sectional diameter of the tubular shape at any point along the tubular shape.

In some embodiments, the composition, fiber, or membrane of the disclosure can be a tubular shape that is from about 1 cm to about 2 m long. In some embodiments, the composition, fiber, or membrane of the disclosure can be a tubular shape that is from about 1 cm to about 10 cm, from about 10 cm to about 20 cm, from about 20 cm to about 30 cm, from about 30 cm to about 40 cm, from about 40 cm to about 50 cm, from about 50 cm to about 60 cm, from about 60 cm to about 70 cm, from about 70 cm to about 80 cm, from about 80 cm to about 90 cm, from about 90 cm to about 1 m, from about 1 m to about 1.1 m, from about 1.1 m to about 1.2 m, from about 1.2 m to about 1.3 m, from about 1.3 m to about 1.4 m, from about 1.4 m to about 1.5 m, from about 1.5 m to about 1.6 m, from about 1.6 m to about 1.7 m, from about 1.7 m to about 1.8 m, from about 1.8 m to about 1.9 m, or from about 1.9 m to about 2 m long. In some embodiments, the composition, fiber, or membrane of the disclosure can be a tubular shape that is about 1 cm, about 5 cm, about 10 cm, about 15 cm, about 20 cm, about 25 cm, about 30 cm, about 35 cm, about 40 cm, about 45 cm, about 50 cm, about 55 cm, about 60 cm, about 65 cm, about 70 cm, about 75 cm, about 80 cm, about 85 cm, about 90 cm, about 95 cm, about 1 m, about 1.1 m, about 1.2 m, about 1.3 m, about 1.4 m, about 1.5 m, about 1.6 m, about 1.7 m, about 1.8 m, about 1.9 m, or about 2 m long. In some embodiments, the composition, fiber, or membrane of the disclosure can be a tubular shape that is about 30 cm long. In some embodiments, the composition, fiber, or membrane of the disclosure can be a tubular shape that is about 1 m long. In some embodiments, the composition, fiber, or membrane of the disclosure can be a tubular shape that is about 1.5 m long.

In some embodiments, the composition, fiber, or membrane of the disclosure can be a tubular shape that is has a cross-sectional diameter that is from about 0.5 mm to about 5 mm. In some embodiments, the composition, fiber, or membrane of the disclosure can be a tubular shape that is has a cross-sectional diameter that is from about 0.5 mm to about 0.6 mm, from about 0.6 mm to about 0.7 mm, from about 0.7 mm to about 0.8 mm, from about 0.8 mm to about 0.9 mm, from about 0.9 mm to about 1 mm, from about 1 mm to about 1.2 mm, from about 1.2 mm to about 1.4 mm, from about 1.4 mm to about 1.6 mm, from about 1.6 mm to about 1.8 mm, from about 1.8 mm to about 2 mm, from about 2 mm to about 2.2 mm, from about 2.2 mm to about 2.4 mm, from about 2.4 mm to about 2.6 mm, from about 2.6 mm to about 2.8 mm, from about 2.8 mm to about 3 mm, from about 3 mm to about 3.2 mm, from about 3.2 mm to about 3.4 mm, from about 3.4 mm to about 3.6 mm, from about 3.6 mm to about 3.8 mm, from about 3.8 mm to about 4 mm, from about 4 mm to about 4.2 mm, from about 4.2 mm to about 4.4 mm, from about 4.4 mm to about 4.6 mm, from about 4.6 mm to about 4.8 mm, or from about 4.8 mm to about 5 mm. In some embodiments, the composition, fiber, or membrane of the disclosure can be a tubular shape that is has a cross-sectional diameter that is about 0.5 mm, about 0.6 mm, about 0.7 mm, about 0.8 mm, about 0.9 mm, about 1 mm, about 1.2 mm, about 1.4 mm, about 1.6 mm, about 1.8 mm, about 2 mm, about 2.2 mm, about 2.4 mm, about 2.6 mm, about 2.8 mm, about 3 mm, about 3.2 mm, about 3.4 mm, about 3.6 mm, about 3.8 mm, about 4 mm, about 4.2 mm, about 4.4 mm, about 4.6 mm, about 4.8 mm, or about 5 mm.

In some embodiments, the inner layer is a hollow fiber membrane. In some embodiments, the inner layer comprises a fluoropolymer. In some embodiments, the fluoropolymer is a thermoplastic fluoropolymer. In some embodiments, the fluoropolymer is polyvinylidene fluoride (PVDF). In some embodiments, the fluoropolymer is ethylene chlorotrifluoroethylene (ECTFE). In some embodiments, the fluoropolymer is perfluoroalkoxy (PFA). In some embodiments, the fluoropolymer is fluorinated ethylene propylene (FEP).

### A. Inner Layer of Hollow Fiber Membranes

In some embodiments, the inner layer further comprises polyethylene glycol (PEG). In some embodiments, the PEG is PEG-4000. In some embodiments, the PEG is PEG-6000. In some embodiments, the PEG is PEG-8000. In some embodiments, the inner layer comprises from about 1% to about 2.5%, from about 2.5% to about 5%, from about 5% to about 7.5%, from about 7.5% to about 10%, from about 10% to about 12.5%, or from about 12.5% to about 15% (wt %) of PEG. In some embodiments the inner layer comprises about 1%, about 2.5%, about 5%, about 7.5%, about 10%, about 12.5% or about 15% (wt %) of PEG. In some embodiments, the inner layer comprises from about 3% to about 15% (wt %) of PEG. In some embodiments, the inner layer comprises about 10% (wt %) of PEG. the inner layer comprises about 12% (wt %) of PEG.

In some embodiments, the inner layer can have a mean thickness of from about 10 μm to about 500 μm. In some embodiments, the inner layer can have a mean thickness of from about 10 μm to about 50 μm, from about 50 μm to about 100 μm, from about 100 μm to about 150 μm, from about 150 μm to about 200 μm, from about 200 μm to about 250 μm, from about 250 μm to about 300 μm, from about 300 μm to about 350 μm, from about 350 μm to about 400 μm, from about 400 μm to about 450 μm, or from about 450 μm to about 500 μm. In some embodiments, the inner layer has a mean thickness of about 10 μm, about 50 μm, about 100 μm, about 150 μm, about 200 μm, about 250 μm, about 300 μm, about 350 μm, about 400 μm, about 450 μm, or about 500 μm. In some embodiments, the inner layer has a mean thickness of about 100 μm. In some embodiments, the inner layer has a mean thickness of about 135 μm. In some embodiments, the inner layer has a mean thickness of about 150 μm.

In some embodiments, the inner layer can have a median pore size of from about 0.1 μm to about 0.5 μm. In some embodiments, the inner layer can have a median pore size of from about 0.1 μm to about 0.15 μm, from about 0.15 μm to about 0.2 μm, from about 0.2 μm to about 0.25 μm, from about 0.25 μm to about 0.3 μm, from about 0.3 μm to about 0.35 μm, from about 0.35 μm to about 0.4 μm, from about 0.4 μm to about 0.45 μm, or from about 0.45 μm to about 0.5 μm. In some embodiments, the inner layer has a median pore size of about 0.1 μm, about 0.15 μm, about 0.2 μm, about 0.25 μm, about 0.3 μm, about 0.35 μm, about 0.4 μm, about 0.45 μm, or about 0.5 μm. In some embodiments, the inner layer has a median pore size of about 0.2 μm. In some embodiments, the inner layer has a median pore size of about 0.3 μm. In some embodiments, the inner layer has a median pore size of about 0.4 μm.

In some embodiments, the inner layer can have a mean pore size of from about 0.1 μm to about 0.5 μm. In some embodiments, the inner layer can have a mean pore size of from about 0.1 μm to about 0.15 μm, from about 0.15 μm to about 0.2 μm, from about 0.2 μm to about 0.25 μm, from about 0.25 μm to about 0.3 μm, from about 0.3 μm to about 0.35 μm, from about 0.35 μm to about 0.4 μm, from about 0.4 μm to about 0.45 μm, or from about 0.45 μm to about 0.5 μm. In some embodiments, the inner layer has a mean pore size of about 0.1 μm, about 0.15 μm, about 0.2 μm, about 0.25 μm, about 0.3 μm, about 0.35 μm, about 0.4 μm, about 0.45 μm, or about 0.5 μm. In some embodiments, the inner layer has a mean pore size of about 0.25 μm. In some embodiments, the inner layer has a mean pore size of about 0.27 μm. In some embodiments, the inner layer has a mean pore size of about 0.3 μm.

In some embodiments, the inner layer can have a maximum pore size of from about 0.2 μm to about 0.6 μm. In some embodiments, the inner layer can have a maximum pore size of from about 0.2 μm to about 0.25 μm, from about 0.25 μm to about 0.3 μm, from about 0.3 μm to about 0.35 μm, from about 0.35 μm to about 0.4 μm, from about 0.4 μm to about 0.45 μm, from about 0.45 μm to about 0.5 μm, from about 0.5 μm to about 0.55 μm, or from about 0.55 μm to about 0.6 μm. In some embodiments, the inner layer can have a maximum pore size of about 0.2 μm, about 0.25 μm, about 0.3 μm, about 0.35 μm, about 0.4 μm, about 0.45 μm, about 0.5 μm, about 0.55 μm, or about 0.6 μm. In some embodiments, the inner layer has a maximum pore size of about 0.3 μm. In some embodiments, the inner layer has a maximum pore size of about 0.4 μm. In some embodiments, the inner layer has a maximum pore size of about 0.5 μm.

In some embodiments, the inner layer has a percentage of void space, also known as porosity, of from about 70% to about 99%. In some embodiments, the inner layer has a porosity of from about 70% to about 75%, from about 75% to about 80%, from about 80% to about 85%, from about 85% to about 90%, from about 90% to about 95%, or from about 95% to about 99%. In some embodiments, the inner layer has a porosity of about 70%, about 75%, about 80%, about 85%, about 90%, about 95%, or about 99%. In some embodiments, the inner layer has a porosity of at least about 70%, at least about 75%, at least about 80%, at least about 85%, at least about 90%, at least about 95%, or at least about 99%. In some embodiments, the inner layer has a porosity of about 75%. In some embodiments, the inner layer has a porosity of about 80%. In some embodiments, the inner layer has a porosity of about 75%.

In some embodiments, the water contact angle of the inner layer can be determined. In some embodiments, a water contact angle can be determined using a tensiometer. In some embodiments, an average of three tensiometer measurements can be used to determine the water contact angle of an inner layer. In some embodiments, when the inner layer is placed on a surface, the inner layer can form an angle between the surface and a line tangent to the edge of the inner layer (i.e., hydrophobicity or water contact angle) of from about 0° to about 90°. In some embodiments, the inner layer can have a water contact angle of from about 0° to about 5°, from about 5° to about 10°, from about 10° to about 15°, from about 15° to about 20°, from about 20° to about 25°, from about 25° to about 30°, from about 30° to about 35°, from about 35° to about 40°, from about 40° to about 45°, from about 45° to about 50°, from about 50° to about 55°, from about 55° to about 60°, from about 60° to about 65°, from about 65° to about 70°, from about 70° to about 75°, from about 75° to about 80°, from about 80° to about 85°, or from about 85° to about 90°. In some embodiments, the inner layer can have a water contact angle of about 5°, about 10°, about 15°, about 20°, about 25°, about 30°, about 35°, about 40°, about 45°, about 50°, about 55°, about 60°, about 65°, about 70°, about 75°, about 80°, about 85°, or about 90°. In some embodiments, the inner layer can have a water contact angle of about 40°. In some embodiments, the inner layer can have a water contact angle of about 45°. In some embodiments, the inner layer can have a water contact angle of about 47°.

In some embodiments, the inner layer's mechanical properties, such as maximum tensile strength and Young's modulus can be tested using an MTS Criterion Model 44 TM, with a starting gauge length of about 50 mm and an elongation rate of about 50 mm/min. In some embodiments, and average of 10 measurements can be used to determine the mechanical properties of the inner layer.

In some embodiments, the inner layer can exhibit physical robustness through a tensile strength of from at least about 2 MPa to at least about 5 MPa. In some embodiments, the inner layer can exhibit a tensile strength of from at least about 2 MPa to at least about 2.5 MPa, from at least about 2.5 MPa to at least about 3 MPa, from at least about 3 MPa to at least about 3.5 MPa, from at least about 3.5 MPa to at least about 4 MPa, from at least about 4 MPa to at least about 4.5 MPa, or from at least about 4.5 MPa to at least about 5 MPa. In some embodiments, the inner layer can exhibit a tensile strength of at least about 2 MPa, at least about 2.5 MPa, at least about 3 MPa, at least about 3.5 MPa, at least about 4 MPa, at least about 4.5 MPa, or at least about 5 MPa. In some embodiments, the inner layer can exhibit a tensile strength of at least about 2 MPa. In some embodiments, the inner layer can exhibit a tensile strength of at least about 3.5 MPa. In some embodiments, the inner layer can exhibit a tensile strength of at least about 3.8 MPa.

In some embodiments, the inner layer can exhibit physical robustness through a Young's modulus of from at least about 50 MPa to about 90 MPa. In some embodiments, the inner layer can have a Young's modulus of from at least about 50 MPa to about 55 MPa, from at least about 55 MPa to about 60 MPa, from at least about 60 MPa to about 65 MPa, from at least about 65 MPa to about 70 MPa, from at least about 70 MPa to about 75 MPa, from at least about 75 MPa to about 80 MPa, from at least about 80 MPa to about 85 MPa, or from at least about 85 MPa to about 90 MPa. In some embodiments, the inner layer can have a Young's modulus of at least about 50 MPa, at least about 55 MPa, at least about 60 MPa, at least about 65 MPa, at least about 70 MPa, at least about 75 MPa, at least about 80 MPa, at least about 85 MPa, or at least about 90 MPa. In some embodiments, the inner layer can have a Young's modulus of at least about 60 MPa. In some embodiments, the inner layer can have a Young's modulus of at least about 70 MPa. In some embodiments, the inner layer can have a Young's modulus of at least about 75 MPa. In some embodiments, the inner layer can have a Young's modulus of at least about 79 MPa.

In some embodiments, the inner layer can energy efficiency (thermal stability) of at least about 70%, at least about 75%, at least about 80%, at least about 85%, at least about 90%, or at least about 95%. In some embodiments, the inner layer can energy efficiency (thermal stability) of at least about 80%. In some embodiments, the inner layer can energy efficiency (thermal stability) of at least about 85%. In some embodiments, the inner layer can energy efficiency (thermal stability) of at least about 90%.

B. Outer layer of Hollow Fiber Membranes

In some embodiments, a fiber or membrane of the disclosure can comprise an outer layer. In some embodiments, the outer layer can comprise a crosslinked polyvinylidene. In some embodiments, the outer layer is hydrophobic. In some embodiments, the polyvinylidene is PVDF. In some embodiments, there is no separation (i.e., delamination) between the inner layer and the outer layer.

In some embodiments, the outer layer can have a mean thickness of from about 0.1 μm to about 200 μm. In some embodiments, the outer layer can have a mean thickness of from about 0.1 μm to about 0.5 μm, from about 0.5 μm to about 1 μm, from about 1 μm to about 5 μm, from about 5 μm to about 10 μm, from about 10 μm to about 25 μm, from about 25 μm to about 50 μm, from about 50 μm to about 75 μm, from about 75 μm to about 100 μm, from about 100 μm to about 125 μm, from about 125 μm to about 150 μm, from about 150 μm to about 175 μm, or from about 175 μm to about 200 μm. In some embodiments, the outer layer has a mean thickness of about 0.1 μm, about 0.5 μm, about 1 μm, about 5 μm, about 10 μm, about 25 μm, about 50 μm, about 75 μm, about 100 μm, about 125 μm, about 150 μm, about 175 μm, or about 200 μm. In some embodiments, the outer layer has a mean thickness of about 50 μm. In some embodiments, the outer layer has a mean thickness of about 75 μm. In some embodiments, the outer layer has a mean thickness of about 100 μm. In some embodiments, the outer layer has a mean thickness of about 125 μm. In some embodiments, the outer layer has a mean thickness of about 150 μm.

In some embodiments, the outer layer can have a median pore size of from about 0.1 μm to about 0.5 μm. In some embodiments, the outer layer can have a median pore size of from about 0.1 μm to about 0.15 μm, from about 0.15 μm to about 0.2 μm, from about 0.2 μm to about 0.25 μm, from about 0.25 μm to about 0.3 μm, from about 0.3 μm to about 0.35 μm, from about 0.35 μm to about 0.4 μm, from about 0.4 μm to about 0.45 μm, or from about 0.45 μm to about 0.5 μm. In some embodiments, the outer layer has a median pore size of about 0.1 μm, about 0.15 μm, about 0.2 μm, about 0.25 μm, about 0.3 μm, about 0.35 μm, about 0.4 μm, about 0.45 μm, or about 0.5 μm. In some embodiments, the outer layer has a median pore size of about 0.2 μm. In some embodiments, the outer layer has a median pore size of about 0.3 μm. In some embodiments, the outer layer has a median pore size of about 0.4 μm.

In some embodiments, the outer layer can have a mean pore size of from about 0.1 μm to about 0.5 μm. In some embodiments, the outer layer can have a mean pore size of from about 0.1 μm to about 0.15 μm, from about 0.15 μm to about 0.2 μm, from about 0.2 μm to about 0.25 μm, from about 0.25 μm to about 0.3 μm, from about 0.3 μm to about 0.35 μm, from about 0.35 μm to about 0.4 μm, from about 0.4 μm to about 0.45 μm, or from about 0.45 μm to about 0.5 μm. In some embodiments, the outer layer has a mean pore size of about 0.1 μm, about 0.15 μm, about 0.2 μm, about 0.25 μm, about 0.3 μm, about 0.35 μm, about 0.4 μm, about 0.45 μm, or about 0.5 μm. In some embodiments, the outer layer has a mean pore size of about 0.25 μm. In some embodiments, the outer layer has a mean pore size of about 0.27 μm. In some embodiments, the outer layer has a mean pore size of about 0.3 μm.

In some embodiments, the outer layer can have a maximum pore size of from about 0.2 μm to about 0.6 μm. In some embodiments, the outer layer can have a maximum pore size of from about 0.2 μm to about 0.25 μm, from about 0.25 μm to about 0.3 μm, from about 0.3 μm to about 0.35 μm, from about 0.35 μm to about 0.4 μm, from about 0.4 μm to about 0.45 μm, from about 0.45 μm to about 0.5 μm, from about 0.5 μm to about 0.55 μm, or from about 0.55 μm to about 0.6 μm. In some embodiments, the outer layer can have a maximum pore size of about 0.2 μm, about 0.25 μm, about 0.3 μm, about 0.35 μm, about 0.4 μm, about 0.45 μm, about 0.5 μm, about 0.55 μm, or about 0.6 μm. In some embodiments, the outer layer has a maximum pore size of about 0.3 μm. In some embodiments, the outer layer has a maximum pore size of about 0.4 μm. In some embodiments, the outer layer has a maximum pore size of about 0.5 μm.

In some embodiments, the outer layer has a percentage of void space, also known as porosity, of from about 70% to about 99%. In some embodiments, the outer layer has a porosity of from about 70% to about 75%, from about 75% to about 80%, from about 80% to about 85%, from about 85% to about 90%, from about 90% to about 95%, or from about 95% to about 99%. In some embodiments, the outer layer has a porosity of about 70%, about 75%, about 80%, about 85%, about 90%, about 95%, or about 99%. In some embodiments, the outer layer has a porosity of at least about 70%, at least about 75%, at least about 80%, at least about 85%, at least about 90%, at least about 95%, or at least about 99%. In some embodiments, the outer layer has a porosity of about 75%. In some embodiments, the outer layer has a porosity of about 80%. In some embodiments, the outer layer has a porosity of about 75%.

In some embodiments, the water contact angle of the outer layer can be determined. In some embodiments, a water contact angle can be determined using a tensiometer. In some embodiments, an average of three tensiometer measurements can be used to determine the water contact angle of the outer layer. In some embodiments, when the outer layer is placed on a surface, the outer layer can form an angle between the surface and a line tangent to the edge of the outer layer (i.e., hydrophobicity or water contact angle) of from about 90° to about 180°. In some embodiments, the outer layer can have a water contact angle of from about 90° to about 95°, from about 95° to about 100°, from about 100° to about 105°, from about 105° to about 110°, from about 110° to about 115°, from about 115° to about 120°, from about 120° to about 125°, from about 125° to about 130°, from about 130° to about 135°, from about 135° to about 140°, from about 140° to about 145°, from about 145° to about 150°, from about 150° to about 155°, from about 155° to about 160°, from about 160° to about 165°, from about 165° to about 170°, from about 170° to about 175°, or from about 175° to about 180°. In some embodiments, the outer layer can have a water contact angle of about 90°, about 95°, about 100°, about 105°, about 110°, about 115°, about 120°, about 125°, about 130°, about 135°, about 140°, about 145°, about 150°, about 155°, about 160°, about 165°, about 170°, about 175°, or about 180°. In some embodiments, the outer layer can have a water contact angle of about 120°. In some embodiments, the outer layer can have a water contact angle of about 130°. In some embodiments, the outer layer can have a water contact angle of about 140°.

In some embodiments, the outer layer's mechanical properties, such as maximum tensile strength and Young's modulus can be tested using an MTS Criterion Model 44, with a starting gauge length of about 50 mm and an elongation rate of about 50 mm/min. In some embodiments, and average of 10 measurements can be used to determine the mechanical properties of the outer layer.

In some embodiments, the outer layer can exhibit physical robustness through a tensile strength of from at least about 2 MPa to at least about 5 MPa. In some embodiments, the outer layer can exhibit a tensile strength of from at least about 2 MPa to at least about 2.5 MPa, from at least about 2.5 MPa to at least about 3 MPa, from at least about 3 MPa to at least about 3.5 MPa, from at least about 3.5 MPa to at least about 4 MPa, from at least about 4 MPa to at least about 4.5 MPa, or from at least about 4.5 MPa to at least about 5 MPa. In some embodiments, the outer layer can exhibit a tensile strength of at least about 2 MPa, at least about 2.5 MPa, at least about 3 MPa, at least about 3.5 MPa, at least about 4 MPa, at least about 4.5 MPa, or at least about 5 MPa. In some embodiments, the outer layer can exhibit a tensile strength of at least about 2 MPa. In some embodiments, the outer layer can exhibit a tensile strength of at least about 3.5 MPa. In some embodiments, the outer layer can exhibit a tensile strength of at least about 3.8 MPa.

In some embodiments, the outer layer can exhibit physical robustness through a Young's modulus of from at least about 50 MPa to about 90 MPa. In some embodiments, the outer layer can have a Young's modulus of from at least about 50 MPa to about 55 MPa, from at least about 55 MPa to about 60 MPa, from at least about 60 MPa to about 65 MPa, from at least about 65 MPa to about 70 MPa, from at least about 70 MPa to about 75 MPa, from at least about 75 MPa to about 80 MPa, from at least about 80 MPa to about 85 MPa, or from at least about 85 MPa to about 90 MPa. In some embodiments, the outer layer can have a Young's modulus of at least about 50 MPa, at least about 55 MPa, at least about 60 MPa, at least about 65 MPa, at least about 70 MPa, at least about 75 MPa, at least about 80 MPa, at least about 85 MPa, or at least about 90 MPa. In some embodiments, the outer layer can have a Young's modulus of at least about 60 MPa. In some embodiments, the outer layer can have a Young's modulus of at least about 70 MPa. In some embodiments, the outer layer can have a Young's modulus of at least about 75 MPa. In some embodiments, the outer layer can have a Young's modulus of at least about 79 MPa.

In some embodiments, the outer layer can energy efficiency (thermal stability) of at least about 70%, at least about 75%, at least about 80%, at least about 85%, at least about 90%, or at least about 95%. In some embodiments, the outer layer can energy efficiency (thermal stability) of at least about 80%. In some embodiments, the outer layer can energy efficiency (thermal stability) of at least about 85%. In some embodiments, the outer layer can energy efficiency (thermal stability) of at least about 90%.

Methods of using compositions of the disclosure Disclosed herein is a system comprising a plurality of independent fibers, wherein each fiber is independently in fluid communication with a common fluid manifold, wherein each fiber independently comprises: a) an inner layer, wherein the inner layer comprises a fluoropolymer, wherein the inner layer has a tubular shape, wherein the inner layer further comprises an inner surface and an outer surface; and b) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber, wherein each fiber is independently configured to remove an impurity from a fluid sample as the fluid sample passes through the fiber from the common fluid manifold.

Also disclosed herein is a method comprising contacting a fluid sample with a fiber, wherein the fiber comprises: a) an inner layer, wherein the inner layer comprises a fluoropolymer, wherein the inner layer has a tubular shape, wherein the inner layer further comprises an inner surface and an outer surface; and b) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber. In some embodiments, the contacting removes an impurity from the fluid sample.

In some embodiments, a method of the disclosure can remove at least about 85% of the impurity from the sample. In some embodiments, a method of the disclosure can remove at least about 85%, at least about 90%, at least about 91%, at least about 92%, at least about 93%, at least about 94%, at least about 95%, at least about 96%, at least about 97%, at least about 98%, at least about 99%, or at least about 99.5% of the impurity from the sample.

### A. CO₂—Capture

Carbon dioxide (CO₂) capture from the atmosphere, also known as direct air capture (DAC), is a technology that can be used to mitigate climate change by removing large amounts of CO₂ emissions from the atmosphere. DAC can capture emissions from various sources, such as residual emission from flue gas scrubbing and emissions from fossil fuel-burning vehicles. Disclosed herein are methods of capturing CO₂ from a gaseous sample using a DAC system with a liquid or solid sorbent that can selectively bind CO₂ molecules.

In some embodiments, a composition, fiber, or membrane of the disclosure used to capture CO₂ from a gaseous sample can be a Janus HFM (J-HFM) TM. In some embodiments, the J-HFM of the disclosure can comprise two layers. In some embodiments, the J-HFM of the disclosure can comprise a CO₂-philic layer. In some embodiments, the J-HFM of the disclosure can comprise a hydrophobic layer. In some embodiments, the J-HFM of the disclosure can comprise a super-hydrophobic layer. In some embodiments, the J-HFM of the disclosure can comprise a hydrophilic PVDF/PEG layer. In some embodiments, the J-HFM of the disclosure can comprise a hydrophobic PVDF/Si—R layer.

During the CO₂ capture process, the air from the atmosphere can flow along the CO₂-philic inner layer of the dual-layer fiber, and the liquid CO₂-selective solvent can be circulated through the hydrophobic outer layer of the dual-layer fiber. The thick, porous CO₂-philic inner layer can: 1) improve the CO₂ transfer rate with enhanced CO₂ solubility and diffusivity; 2) reduce the required thickness of the super hydrophobic membrane through high mechanical stability; and 3) decrease CO₂ mass transfer resistance in the super hydrophobic layer and achieving a step-change improvement in the CO₂ capture rate. In some embodiments, the super-hydrophobic outer layer can reduce or eliminate direct contact between contaminants in the gaseous sample and solvent. In some embodiments, reducing or eliminating direct contact between contaminants in the gaseous sample and the solvent can improve long-term stability of the fiber by reducing pore wetting. In some embodiments, a reduced transfer distance between the gaseous sample and CO₂-philic solvent can reduce CO₂-liquid mass transfer resistance in the pores and CO₂-membrane mass transfer resistance in the matrix. In some embodiments, fiber resistance can be minimized by reducing the thickness of the inner layer or outer layer of the fiber. In some embodiments, fiber resistance can be minimized by increasing surface porosity.

In some embodiments, the fluid sample is an atmospheric sample. In some embodiments, the impurity is carbon dioxide. In some embodiments, the contacting comprises flowing the atmospheric sample through the tubular channel. In some embodiments, the method can further comprise flowing a solvent through the outer layer. In some embodiments, the solvent is a CO₂-philic solvent. In some embodiments, the CO₂-philic solvent absorbs CO₂ from the atmospheric sample. In some embodiments, the CO₂-philic solvent is a soybean-based solvent. In some embodiments, a soybean-based (SBB) solvent can have a low absorption enthalpy and near-zero vapor pressure (<1.27×10⁻⁹ bar). In some embodiments, the soybean-based solvent comprises at least 10, at least 11, at least 12, at least 13, at least 14, at least 15, at least 16, at least 17, or at least 18 amino acids or salts thereof. In some embodiments, the soybean-based solvent comprises at least 15 amino acids or salts thereof. In some embodiments, the soybean-based solvent comprises at least 16 amino acids or salts thereof. In some embodiments, the soybean-based solvent comprises at least 17 amino acids or salts thereof. In some embodiments, the soybean-based solvent comprises at least 18 amino acids or salts thereof.

In some embodiments, the methods of the disclosure can further comprise regenerating the CO₂-philic solvent by releasing CO₂ from the CO₂-philic solvent. In some embodiments, the regenerating comprises treating the CO₂-philic solvent with an amount of heat suitable to expel CO₂ from the CO₂-philic solvent. In some embodiments, the regenerating comprises treating the CO₂-philic solvent with an amount of pressure suitable to expel CO₂ from the CO₂-philic solvent.

In some embodiments, the amount of heat is from about 80° C. to about 150° C. In some embodiments, the amount of heat is from about 80° C. to about 90° C., from about 90° C. to about 100° C., from about 100° C. to about 110° C., from about 110° C. to about 120° C., from about 120° C. to about 130° C., from about 130° C. to about 140° C., or from about 140° C. to about 150° C. In some embodiments, the amount of heat is about 80° C., about 90° C., about 100° C., about 110° C., about 120° C., about 130° C., about 140° C., or about 150° C. In some embodiments, the amount of heat is about 80° C. In some embodiments, the amount of heat is about 100° C. In some embodiments, the amount of heat is about 120° C.

In some embodiments, the amount of pressure is from about 1 kPa to about 10 kPa. In some embodiments, the amount of pressure is from about 1 kPa to about 2 kPa, from about 2 kPa to about 3 kPa, from about 3 kPa to about 4 kPa, from about 4 kPa to about 5 kPa, from about 5 kPa to about 6 kPa, from about 6 kPa to about 7 kPa, from about 7 kPa to about 8 kPa, from about 8 kPa to about 9 kPa, or from about 9 kPa to about 10 kPa. In some embodiments, the amount of pressure is about 1 kPa, about 2 kPa, about 3 kPa, about 4 kPa, about 5 kPa, about 6 kPa, about 7 kPa, about 8 kPa, about 9 kPa, about 10 kPa. In some embodiments, the amount of pressure is about 2 kPa. In some embodiments, the amount of pressure is about 5 kPa.

In some embodiments, the CO₂/N₂ selectivity of the membrane contactor process is at least about 500:1, at least about 600:1, at least about 700:1, at least about 800:1, at least about 900:1, at least about 1,000:1, at least about 1,100:1, at least about 1,200:1, at least about 1,300:1, at least about 1,400:1, or at least about 1,500:1. In some embodiments, the CO₂/N₂ selectivity of the membrane contactor process is at least about 500:1. In some embodiments, the CO₂/N₂ selectivity of the membrane contactor process is about 500:1, about 600:1, about 700:1, about 800:1, about 900:1, about 1,000:1, about 1,100:1, about 1,200:1, about 1,300:1, about 1,400:1, or about 1,500:1. In some embodiments, the CO₂/N₂ selectivity of the membrane contactor process is about 500:1.

In some embodiments, the CO₂/O₂ selectivity of the membrane contactor process is at least about 500:1, at least about 600:1, at least about 700:1, at least about 800:1, at least about 900:1, at least about 1,000:1, at least about 1,100:1, at least about 1,200:1, at least about 1,300:1, at least about 1,400:1, or at least about 1,500:1. In some embodiments, the CO₂/O₂ selectivity of the membrane contactor process is at least about 500:1. In some embodiments, the CO₂/O₂ selectivity of the membrane contactor process is about 500:1, about 600:1, about 700:1, about 800:1, about 900:1, about 1,000:1, about 1,100:1, about 1,200:1, about 1,300:1, about 1,400:1, or about 1,500:1. In some embodiments, the CO₂/O₂ selectivity of the membrane contactor process is about 500:1.

In some embodiments, the membrane contactor process of the disclosure can achieve at least about 80%, at least about 85%, at least about 90%, at least about 95%, or at least about 99% CO₂ removal. In some embodiments, the membrane contactor process of the disclosure can achieve at least about 90% CO₂ removal. In some embodiments, the membrane contactor process of the disclosure can achieve at least about 95% CO₂ removal. In some embodiments, the membrane contactor process of the disclosure can achieve at least about 99% CO₂ removal.

In some embodiments, the membrane contactor process of the disclosure can achieve about 80%, about 85%, about 90%, about 95%, or about 99% CO₂ removal. In some embodiments, the membrane contactor process of the disclosure can achieve about 90% CO₂ removal. In some embodiments, the membrane contactor process of the disclosure can achieve about 95% CO₂ removal. In some embodiments, the membrane contactor process of the disclosure can achieve about 99% CO₂ removal.

### B. Desalination

Direct contact membrane distillation (DCMD) is a thermal-driven separation process that uses a porous hydrophobic membrane as a barrier to avoid contact between a waste stream and recovered water. DCMD can utilize the low-grade heat, such as a geothermal resource, solar energy, waste heat streams, and subterranean heat. The DCMD process is based on the principle of vapor/liquid equilibrium; thus, the salt rejection can be close to 100% and can be used on hypersalinated water. The temperature difference across the membrane is the driving force of DCMD, and in some embodiments, only water vapor is transported through the pores of the membrane. DCMD is insensitive to the salinity of a feed solution and shows high tolerance of membrane fouling when desalinating high-salinity wastewater, for example, oilfield-produced water or the concentrated product from reverse osmosis (RO).

The morphological architecture of the hydrophobic membrane can play an important role in permeate flux enhancement in DCMD, which involves coupled vapor and heat transportation. The high vapor transfer rate and low conductive heat transfer rate are sometimes preferred for the membranes used for DCMD. In some embodiments, a highly porous and thin membrane is associated with a high mass transport coefficient. In some embodiments, a thick membrane can be used to improve thermal efficiency and mechanical robustness. In some embodiments, a hydrophilic-hydrophobic dual layer membrane can be used to enhance the permeate water flux while maintaining low conductive heat loss and high mechanical strength of the membrane. In some embodiments, a thick hydrophilic layer can be used to decrease the thickness of the hydrophobic membrane, which can shorten the vapor transport distance in DCMD and enhance the permeate water flux. In some embodiments, a thick hydrophilic layer can help maintain mechanical stability and minimize the conductive heat reduction and temperature polarization in DCMD.

Membrane wetting is caused by the fouling of organic matters and inorganic scales from the feed solution and improper operating parameters in DCMD. Improper parameters can lead to significant loss of membrane selectivity and even the water flux reduction. In some embodiments, the fibers or membranes of the disclosure can comprise an anti-wetting membrane. In some embodiments, a dope mixture can comprise at least one additive to improve anti-wetting properties.

In some embodiments, a system or fiber of the disclosure can be used to remove an impurity. In some embodiments, the impurity is a salt. In some embodiments, the impurity is a mineral. In some embodiments, the impurity is NaCl. In some embodiments, the fluid sample is a water sample. In some embodiments, the water sample is obtained from an underground water formation. In some embodiments, the water sample is produced water.

In some embodiments, the fluid sample has a salinity of at least about 20,000 mg/L, at least about 25,000 mg/L, at least about 30,000 mg/L, at least about 35,000 mg/L, at least about 40,000 mg/L, at least about 45,000 mg/L, at least about 50,000 mg/L, at least about 55,000 mg/L, at least about 60,000 mg/L, at least about 65,000 mg/L, at least about 70,000 mg/L, at least about 75,000 mg/L, at least about 80,000 mg/L, at least about 85,000 mg/L, at least about 90,000 mg/L, at least about 100,000 mg/L, at least about 120,000 mg/L, at least about 140,000 mg/L, at least about 160,000 mg/L, at least about 180,000 mg/L, at least about 200,000 mg/L, at least about 220,000 mg/L, at least about 240,000 mg/L, at least about 260,000 mg/L, at least about 280,000 mg/L, or at least about 300,000 mg/L. In some embodiments, the fluid sample has a salinity of at least about 35,000 mg/L. In some embodiments, the fluid sample has a salinity of at least about 50,000 mg/L. In some embodiments, the fluid sample has a salinity of at least about 100,000 mg/L. In some embodiments, the fluid sample has a salinity of at least about 150,000 mg/L. In some embodiments, the fluid sample has a salinity of at least about 200,000 mg/L. In some embodiments, the fluid sample has a salinity of at least about 250,000 mg/L.

In some embodiments, the methods and compositions of the disclosure can have a salt rejection of at least about 80%, at least about 85%, at least about 90%, at least about 95%, at least about 96%, at least about 97%, at least about 98%, at least about 99%, at least about 99.5%, or at least about 99.9%. In some embodiments, the methods and compositions of the disclosure can have a salt rejection of about 80%, about 85%, about 90%, about 95%, about 96%, about 97%, about 98%, about 99%, about 99.5%, or about 99.9%. In some embodiments, the methods and compositions of the disclosure can have a salt rejection of about 90%. In some embodiments, the methods and compositions of the disclosure can have a salt rejection of about 95%. In some embodiments, the methods and compositions of the disclosure can have a salt rejection of about 99%.

In some embodiments, the contacting comprises flowing the fluid sample through the outer layer of the fiber. In some embodiments, the fluid sample is flowed through the outer layer of the membrane. In some embodiments, the fluid sample is flowed through the outer layer of the membrane with a linear velocity of from about 0.5 m/s to about 5 m/s. In some embodiments, the fluid sample is flowed through the outer layer of the membrane with a linear velocity of from about 0.5 m/s to about 1 m/s, from about 1 m/s to about 1.5 m/s, from about 1.5 m/s to about 2 m/s, from about 2 m/s to about 2.5 m/s, from about 2.5 m/s to about 3 m/s, from about 3 m/s to about 3.5 m/s, from about 3.5 m/s to about 4 m/s, from about 4 m/s to about 4.5 m/s, or from about 4.5 m/s to about 5 m/s. In some embodiments, the fluid sample is flowed through the outer layer of the membrane with a linear velocity of about 0.5 m/s, about 1 m/s, about 1.5 m/s, about 2 m/s, about 2.5 m/s, about 3 m/s, about 3.5 m/s, about 4 m/s, about 4.5 m/s, or about 5 m/s. In some embodiments, the fluid sample is flowed through the outer layer of the membrane with a linear velocity of about 1.5 m/s. In some embodiments, the fluid sample is flowed through the outer layer of the membrane with a linear velocity of about 2 m/s. In some embodiments, the fluid sample is flowed through the outer layer of the membrane with a linear velocity of about 2.5 m/s.

In some embodiments, a method of the disclosure can further comprise flowing fresh water through the tubular channel. In some embodiments, fresh water is deionized water. In some embodiments, fresh water is river water. In some embodiments, fresh water is tap water. In some embodiments, fresh water has a salinity of from about 500 mg/L to about 10,000 mg/L. In some embodiments, fresh water has a salinity of from about 500 mg/L to about 1,000 mg/L, from about 1,000 mg/L to about 1,500 mg/L, from about 1,500 mg/L to about 2,000 mg/L, from about 2,000 mg/L to about 2,500 mg/L, from about 2,500 mg/L to about 3,000 mg/L, from about 3,000 mg/L to about 3,500 mg/L, from about 3,500 mg/L to about 4,000 mg/L, from about 4,000 mg/L to about 4,500 mg/L, from about 4,500 mg/L to about 5,000 mg/L, from about 5,000 mg/L to about 5,500 mg/L, from about 5,500 mg/L to about 6,000 mg/L, from about 6,000 mg/L to about 6,500 mg/L, from about 6,500 mg/L to about 7,000 mg/L, from about 7,000 mg/L to about 7,500 mg/L, from about 7,500 mg/L to about 8,000 mg/L, from about 8,000 mg/L to about 8,500 mg/L, from about 8,500 mg/L to about 9,000 mg/L, from about 9,000 mg/L to about 9,500 mg/L, or from about 9,500 mg/L to about 10,000 mg/L. In some embodiments, fresh water has a salinity of about 500 mg/L, about 1,000 mg/L, about 1,500 mg/L, about 2,000 mg/L, about 2,500 mg/L, about 3,000 mg/L, about 3,500 mg/L, about 4,000 mg/L, about 4,500 mg/L, about 5,000 mg/L, about 5,500 mg/L, about 6,000 mg/L, about 6,500 mg/L, about 7,000 mg/L, about 7,500 mg/L, about 8,000 mg/L, about 8,500 mg/L, about 9,000 mg/L, about 9,500 mg/L, or about 10,000 mg/L. In some embodiments, fresh water has a salinity of about 500 mg/L. In some embodiments, fresh water has a salinity of about 5,000 mg/L. In some embodiments, fresh water has a salinity of about 10,000 mg/L.

In some embodiments, the fresh water is flowed through the tubular channel. In some embodiments, the fresh water is flowed through the tubular channel with a linear velocity of from about 0.2 m/s to about 5 m/s. In some embodiments, the fresh water is flowed through the tubular channel with a linear velocity of from about 0.2 m/s to about 0.5 m/s, from about 0.5 m/s to about 1 m/s, from about 1 m/s to about 1.5 m/s, from about 1.5 m/s to about 2 m/s, from about 2 m/s to about 2.5 m/s, from about 2.5 m/s to about 3 m/s, from about 3 m/s to about 3.5 m/s, from about 3.5 m/s to about 4 m/s, from about 4 m/s to about 4.5 m/s, or from about 4.5 m/s to about 5 m/s. In some embodiments, the fresh water is flowed through the tubular channel with a linear velocity of about 0.2 m/s, about 0.5 m/s, about 1 m/s, about 1.5 m/s, about 2 m/s, about 2.5 m/s, about 3 m/s, about 3.5 m/s, about 4 m/s, about 4.5 m/s, about 5 m/s. In some embodiments, the fresh water is flowed through the tubular channel with a linear velocity of about 1 m/s. In some embodiments, the fresh water is flowed through the tubular channel with a linear velocity of about 2 m/s. In some embodiments, the fresh water is flowed through the tubular channel with a linear velocity of about 3 m/s.

In some embodiments, a method of the disclosure can further comprise: a) flowing the fluid sample through the outer layer of the membrane; and b) flowing fresh water through the tubular channel. In some embodiments, the fluid sample has a fluid sample temperature, the fresh water has a fresh water temperature, and wherein the fluid sample temperature and the fresh water temperature have a difference of from at least about 10° C. to at least about 80° C. In some embodiments, the fluid sample has a fluid sample temperature, the fresh water has a fresh water temperature, and wherein the fluid sample temperature and the fresh water temperature have a difference of from at least about 10° C. to at least about 15° C., from at least about 15° C. to at least about 20° C., from at least about 20° C. to at least about 25° C., from at least about 25° C. to at least about 30° C., from at least about 30° C. to at least about 35° C., from at least about 35° C. to at least about 40° C., from at least about 40° C. to at least about 45° C., from at least about 45° C. to at least about 50° C., from at least about 50° C. to at least about 55° C., from at least about 55° C. to at least about 60° C., from at least about 60° C. to at least about 65° C., from at least about 65° C. to at least about 70° C., from at least about 70° C. to at least about 75° C., or from at least about 75° C. to at least about 80° C. In some embodiments, the fluid sample has a fluid sample temperature, the fresh water has a fresh water temperature, and wherein the fluid sample temperature and the fresh water temperature have a difference of from at least about 10° C., at least about 15° C., at least about 20° C., at least about 25° C., at least about 30° C., at least about 35° C., at least about 40° C., at least about 45° C., at least about 50° C., at least about 55° C., at least about 60° C., at least about 65° C., at least about 70° C., at least about 75° C., or at least about 80° C. In some embodiments, the fluid sample has a fluid sample temperature, the fresh water has a fresh water temperature, and wherein the fluid sample temperature and the fresh water temperature have a difference of about 20° C. In some embodiments, the fluid sample has a fluid sample temperature, the fresh water has a fresh water temperature, and wherein the fluid sample temperature and the fresh water temperature have a difference of about 50° C. In some embodiments, the fluid sample has a fluid sample temperature, the fresh water has a fresh water temperature, and wherein the fluid sample temperature and the fresh water temperature have a difference of about 70° C.

In some embodiments, the methods of the disclosure can recover water from the water sample. In some embodiments, the methods of the disclosure can recover at least about 70%, at least about 75%, at least about 80%, at least about 85%, at least about 90%, or at least about 90% of the water from the water sample. In some embodiments, the methods of the disclosure can recover at least about 70% of the water from the water sample. In some embodiments, the methods of the disclosure can recover at least about 75% of the water from the water sample. In some embodiments, the methods of the disclosure can recover at least about 80% of the water from the water sample. In some embodiments, the methods of the disclosure can recover at least about 85% of the water from the water sample.

### Methods of Making Membranes of the Disclosure

The dual-layer fibers or membranes of the disclosure can be prepared using a single-step nonsolvent-induced phase inversion (NIPS) method. Polymer dope solutions can be prepared by dissolving specific polymer materials in suitable solvents to form homogeneous dope solutions. The dope solutions can then be co-extruded through a triple-orifice spinneret and subsequently immersed in a non-solvent bath to induce polymer precipitation. In some embodiments, the non-solvent bath is a water bath. In some embodiments, the fibers or membranes of the disclosures are prepared using a co-extrusion spinning technique.

Disclosed herein is a method of making a fiber, the method comprising co-extruding a first dope mixture and a second dope mixture, wherein: a) the first dope mixture comprises a first fluoropolymer, polyethylene glycol (PEG), and a solvent; and b) the second dope mixture comprises a second fluoropolymer and a crosslinking agent, wherein the fiber comprises i) an inner layer, wherein the inner layer comprises a fluoropolymer, wherein the inner layer has a tubular shape, wherein the inner layer further comprises an inner surface and an outer surface; and ii) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber.

Further disclosed herein is an article of manufacture comprising co-extruding a first dope mixture and a second dope mixture, wherein: a) the first dope mixture comprises a first fluoropolymer, polyethylene glycol (PEG), and a solvent; and b) the second dope mixture comprises a second fluoropolymer and a crosslinking agent, wherein the fiber comprises i) an inner layer, wherein the inner layer comprises a fluoropolymer, wherein the inner layer has a tubular shape, wherein the inner layer further comprises an inner surface and an outer surface; and ii) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber.

In some embodiments, the second dope mixture comprises a second fluoropolymer and a crosslinking agent. In some embodiments, the second dope mixture further comprises a second solvent. In some embodiments, the second dope mixture further comprises water. In some embodiments, the second dope solution consists essentially of the second fluoropolymer, the crosslinking agent, a second solvent, and water.

In some embodiments, the first fluoropolymer is a thermoplastic fluoropolymer. In some embodiments, the first fluoropolymer is polyvinylidene fluoride (PVDF). In some embodiments, the first fluoropolymer is ethylene chlorotrifluoroethylene (ECTFE). In some embodiments, the first fluoropolymer is perfluoroalkoxy (PFA). In some embodiments, the first fluoropolymer is fluorinated ethylene propylene (FEP).

In some embodiments, the first fluoropolymer is present in the first dope mixture in an amount of from about 5% to about 15% (wt %). In some embodiments, the first fluoropolymer is present in the first dope mixture in an amount of from about 5% to about 6%, from about 6% to about 7%, from about 7% to about 8%, from about 8% to about 9%, from about 9% to about 10%, from about 10% to about 11%, from about 11% to about 12%, from about 12% to about 13%, from about 13% to about 14%, or from about 14% to about 15% (wt %). In some embodiments, the first fluoropolymer is present in the first dope mixture in an amount of about 5%, about 5.5%, about 6%, about 6.5%, about 7%, about 7.5%, about 8%, about 8.5%, about 9%, about 9.5%, about 10%, about 10.5%, about 11%, about 11.5%, about 12%, about 12.5%, about 13%, about 13.5%, about 14%, about 14.5%, or about 15% (wt %). In some embodiments, the first fluoropolymer is present in the first dope mixture in an amount of about 10% (wt %). In some embodiments, the first fluoropolymer is present in the first dope mixture in an amount of about 12% (wt %). In some embodiments, the first fluoropolymer is present in the first dope mixture in an amount of about 14% (wt %).

In some embodiments, the PEG is PEG-4000. In some embodiments, the PEG is PEG-6000. In some embodiments, the PEG is PEG-8000. In some embodiments the PEG is present in the first dope mixture in an amount of from about 3% to about 12% (wt %). In some embodiments the PEG is present in the first dope mixture in an amount of from about 3% to about 4%, from about 4% to about 5%, from about 5% to about 6%, from about 6% to about 7%, from about 7% to about 8%, from about 8% to about 9%, from about 9% to about 10%, from about 10% to about 11%, or from about 11% to about 12% (wt %). In some embodiments the PEG is present in the first dope mixture in an amount of about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 10.5%, about 11%, about 11.5%, or about 12% (wt %). In some embodiments the PEG is present in the first dope mixture in an amount of about 4%. In some embodiments the PEG is present in the first dope mixture in an amount of about 6%. In some embodiments the PEG is present in the first dope mixture in an amount of about 8%.

In some embodiments, the solvent is an organic solvent. In some embodiments, the solvent is N-methyl-2-pyrrolidone (NMP). In some embodiments, the solvent is dimethylformamide (DMF). In some embodiments, the solvent is dimethyl acetamide (DMAC).

In some embodiments, the solvent is present in the first dope mixture in an amount of from about 75% to about 95% (wt %). In some embodiments, the solvent is present in the first dope mixture in an amount of from about 75% to about 80%, from about 80% to about 85%, from about 85% to about 90%, or from about 90% to about 95% (wt %). In some embodiments, the solvent is present in the first dope mixture in an amount of about 75%, about 80%, about 85%, about 90%, or about 95% (wt %). In some embodiments, the solvent is present in the first dope mixture in an amount of about 80% (wt %). In some embodiments, the solvent is present in the first dope mixture in an amount of about 85% (wt %). In some embodiments, the solvent is present in the first dope mixture in an amount of about 90% (wt %).

In some embodiments, the second fluoropolymer is a thermoplastic polymer. In some embodiments, the second fluoropolymer is polyvinylidene fluoride (PVDF). In some embodiments, the second fluoropolymer is ethylene chlorotrifluoroethylene (ECTFE). In some embodiments, the second fluoropolymer is perfluoroalkoxy (PFA). In some embodiments, the second fluoropolymer is fluorinated ethylene propylene (FEP).

In some embodiments, the second fluoropolymer is present in the second dope mixture in an amount of from about 5% to about 15% (wt %). In some embodiments, the second fluoropolymer is present in the second dope mixture in an amount of from about 5% to about 6%, from about 6% to about 7%, from about 7% to about 8%, from about 8% to about 9%, from about 9% to about 10%, from about 10% to about 11%, from about 11% to about 12%, from about 12% to about 13%, from about 13% to about 14%, or from about 14% to about 15% (wt %). In some embodiments, the second fluoropolymer is present in the second dope mixture in an amount of about 5%, about 5.5%, about 6%, about 6.5%, about 7%, about 7.5%, about 8%, about 8.5%, about 9%, about 9.5%, about 10%, about 10.5%, about 11%, about 11.5%, about 12%, about 12.5%, about 13%, about 13.5%, about 14%, about 14.5% or about 15% (wt %). In some embodiments, the second fluoropolymer is present in the second dope mixture in an amount of about 10% (wt %). In some embodiments, the second fluoropolymer is present in the second dope mixture in an amount of about 12% (wt %). In some embodiments, the second fluoropolymer is present in the second dope mixture in an amount of about 14% (wt %).

In some embodiments, the water is present in the second dope mixture in an amount of from about 0.5% to about 10% (wt %). In some embodiments, the water is present in the second dope mixture in an amount of from about 0.5% to about 1%, from about 1% to about 2%, from about 2% to about 3%, from about 3% to about 4%, from about 4% to about 5%, from about 5% to about 6%, from about 6% to about 7%, from about 7% to about 8%, from about 8% to about 9%, or from about 9% to about 10% (wt %). In some embodiments, the water is present in the second dope mixture in an amount of about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, or about 10% (wt %). In some embodiments, the water is present in the second dope mixture in an amount of about 1.5% (wt %). In some embodiments, the water is present in the second dope mixture in an amount of about 2% (wt %). In some embodiments, the water is present in the second dope mixture in an amount of about 2.5% (wt %).

In some embodiments, the second solvent is an organic solvent. In some embodiments, the second solvent is NMP. In some embodiments, the second solvent is dimethylformamide (DMF). In some embodiments, the second solvent is dimethyl acetamide (DMAC).

In some embodiments, the second solvent is present in the second dope mixture in an amount of from about 75% to about 90% (wt %). In some embodiments, the solvent is present in the second dope mixture in an amount of from about 75% to about 80%, from about 80% to about 85%, or from about 85% to about 90% (wt %). In some embodiments, the solvent is present in the second dope mixture in an amount of about 75%, about 80%, about 85%, or about 90% (wt %). In some embodiments, the solvent is present in the second dope mixture in an amount of about 80% (wt %). In some embodiments, the solvent is present in the second dope mixture in an amount of about 85% (wt %). In some embodiments, the solvent is present in the second dope mixture in an amount of about 90% (wt %).

In some embodiments, the first dope mixture and the second dope mixture are co-extruded into an external coagulant. In some embodiments, the external coagulant is water.

During the phase inversion process, the homogeneous dope mixtures are separated into two phases: a polymer-rich phase to form a membrane matrix; and a polymer-poor phase that forms membrane pores after its removal from the polymer dope solution. To avoid delamination between the inner porous supporting layer and the outer selective layer, spinning parameters can be adjusted. In some embodiments, the adjusted spinning parameter is a dope mixture composition. In some embodiments, the adjusted spinning parameter is bore fluid composition. In some embodiments, the adjusted spinning parameter is the ratio of the outer layer dope solution flow rate to the inner layer dope solution flow rate.

In some embodiments, a dope mixture can be formulated with an equal amount of a crosslinking agent and mixed additive. In some embodiments, a dope mixture can be formulated using about 1% of a crosslinking agent and about 1% water as a mixed additive. In some embodiments, a dope mixture can be formulated using about 2% of a crosslinking agent and about 2% water as a mixed additive. In some embodiments, a dope mixture can be formulated using about 3% of a crosslinking agent and about 3% water as a mixed additive. In some embodiments, a dope mixture can be formulated using about 4% of a crosslinking agent and about 4% water as a mixed additive. In some embodiments, a dope mixture can be formulated using about 5% of a crosslinking agent and about 5% water as a mixed additive. In some embodiments, a dope mixture can be formulated using about 2% of ammonium and about 2% water as a mixed additive. In some embodiments, a dope mixture can be formulated using about 3% of ammonium and about 3% water as a mixed additive.

In some embodiments, a dope mixture can be formulated with a different amount of a crosslinking agent and mixed additive. In some embodiments, a dope mixture can be formulated with a ratio of a crosslinking agent and a mixed additive of about 1:2, about 1:3, about 1:4, or about 1:5. In some embodiments, a dope mixture can be formulated using about 1 part ammonium to about 2 parts water as a mixed additive. In some embodiments, a dope mixture can be formulated using about 1 part ammonium to about 3 parts water as a mixed additive. In some embodiments, a dope mixture can be formulated with a ratio of a crosslinking agent and a mixed additive of about 2:1, about 3:1, about 4:1, or about 5:1. In some embodiments, a dope mixture can be formulated using about 2 parts ammonium to about 1 part water as a mixed additive. In some embodiments, a dope mixture can be formulated using about 3 parts ammonium to about 1 part water as a mixed additive.

In some embodiments, a fiber or membrane of the disclosure can be fabricated using a dope mixture that was exposed to air. This exposure allows for initial PVDF crystallization before starting the spinning process. In some embodiments, a fiber or membrane of the disclosure can be fabricated using a dope mixture that was exposed to air for more than about 1 day, more than about 2 days, more than about 3 days, more than about 4 days, more than about 5 days, more than about 6 days, more than about 7 days, more than about 8 days, more than about 9 days, more than about 10 days, more than about 11 days, more than about 12 days, more than about 13 days, or more than about 14 days. In some embodiments, a fiber or membrane of the disclosure can be fabricated using a dope mixture that was exposed to air for about 1 day, about 2 days, about 3 days, about 4 days, about 5 days, about 6 days, about 7 days, about 8 days, about 9 days, about 10 days, about 11 days, about 12 days, about 13 days, or about 14 days.

In some embodiments, the fibers or membranes of the disclosure can exhibit low thermal conductivity, optimum membrane thickness, optimum pore size, narrow pore size distribution, high porosity, hydrophobicity, degrees of pores interconnectivity, good chemical resistance, thermal stability, or physical robustness.

In some embodiments, the fibers or membranes of the disclosure can have a tolerance of fouling that remains high for at least 100 hours, at least 150 hours, at least 200 hours, at least 250 hours, at least 300 hours, at least 350 hours, at least 400 hours, at least 450 hours, or at least 400 hours of operating the fiber or membrane. In some embodiments, the fibers or membranes of the disclosure can have a tolerance of fouling that remains high for at least 1 month, at least 2 months, at least 3 months, at least 4 months, at least 5 months, at least 6 months, at least 7 months, at least 8 months, at least 9 months, at least 10 months, at least 11 months, or at least 12 months of operating the fiber or membrane. In some embodiments, the fibers or membranes of the disclosure have a tolerance of fouling that remains high for at least 1 year, at least 2 years, at least 3 years, at least 4 years, at least 5 years, at least 6 years, at least 7 years, at least 8 years, at least 9 years, or at least 10 years of operating the fiber or membrane.

In some embodiments, the fibers or membranes of the disclosure can have a tolerance of fouling that remains high for about 100 hours, about 150 hours, about 200 hours, about 250 hours, about 300 hours, about 350 hours, about 400 hours, about 450 hours, or about 500 hours of operating the fiber or membrane. In some embodiments, the fibers or membranes of the disclosure have a tolerance of fouling that remains high for about 1 month, about 2 months, about 3 months, about 4 months, about 5 months, about 6 months, about 7 months, about 8 months, about 9 months, about 10 months, about 11 months, or about 12 months of operating the fiber or membrane. In some embodiments, the fibers or membranes of the disclosure have a tolerance of fouling that remains high for about 1 year, about 2 years, about 3 years, about 4 years, about 5 years, about 6 years, about 7 years, about 8 years, about 9 years, or about 10 years of operating the fiber or membrane.

### EXAMPLES

### Example 1: Preparation of Hollow Fiber Membrane

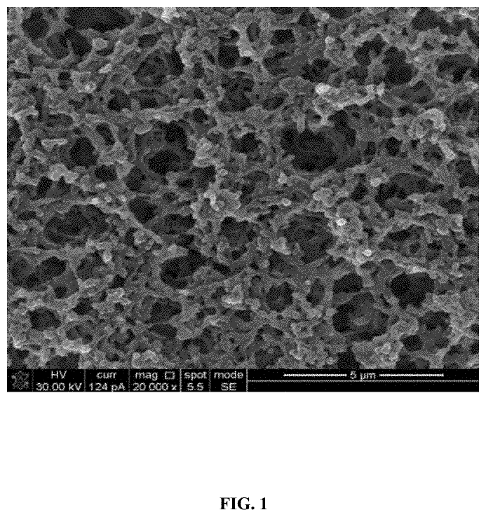

A PVDF HFM was prepared and characterized. The membrane had a membrane thickness of 135 μm, mean pore size of 0.27 μm, maximum pore size of 0.40 μm, high porosity (80.6%), hydrophobicity (water contact angle, 133.9°), energy efficiency of 90%, tensile strength of 3.87M, and Young's modulus of 78.99 M. The membrane also showed a high degree of pore interconnectivity, as shown in FIG. 1.

### Example 2: Method of Measuring Desalination Performance and Anti-Wetting Behavior of the Hollow Fiber Membranes

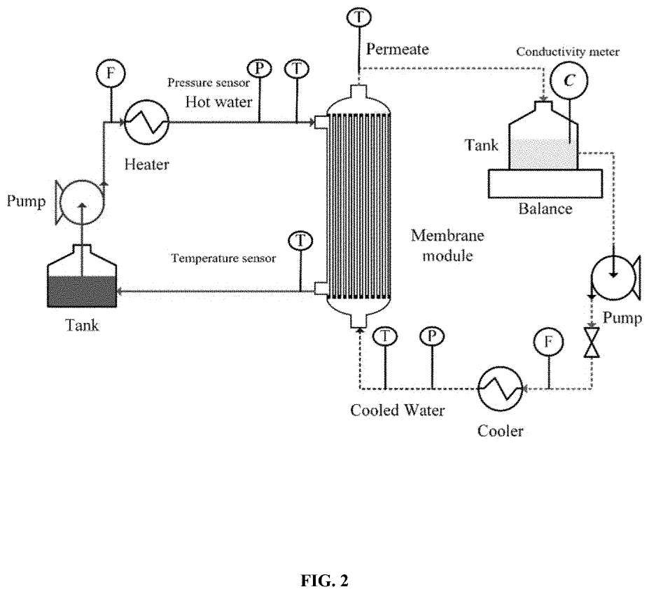

The apparatus used to measure desalination performance and anti-wetting behaviors of the HFMs is schematically shown in FIG. 2. In the DCMD process, a 100 g/L NaCl feed solution was prepared, and deionized water (DI water) was used for the permeate side. The temperatures of the feed solution and the DI water were 60±0.1° C. and 20±0.1° C., respectively. The feed solution was circulated through the shell side of hollow fiber membranes with a linear velocity of 2.0 m/s. DI water was flowed through the lumen side with a linear velocity of 1.0 m/s. The inlet and outlet temperatures of the feed solution and the permeate water were all recorded using four temperature sensors. The weight of the permeate water was measured with a digital scale equipped with a data acquisition system. The electron conductivity of the permeate water was monitored by a TDS/conductivity meter.

The desalination performance was measured in terms of permeate water flux that was recorded by the scale, and the salt rejection that was monitored by the conductivity of the permeate water. The decrease of water flux and salt rejection was considered as the occurring of membrane wetting/fouling. TABLE 1 compares the performance of PVDF membranes.

TABLE 1

| Raw material | | | | Feed solution | | | Permeate solution | | Permeate |
|---|---|---|---|---|---|---|---|---|---|
| and | | Thickness | LEP | Feed | Temperature | | Temperature | | Flux |
| Configuration | Manufacturer | (μm) | (bar) | Composition | (° C) | Velocity | (° C) | Velocity | (kg/m² · h) |
| PVDF | Millipore | 126 | 2.04 | Distilled | 70 | 2.59 | 20 | 4.67 | 32.4 |
| (GVHP) flat | | | | water | | m/s | | | |
| sheet | | | | | | | | | |
| membrane | | | | | | | | | |
| polypropylene | Accurel | 150 | — | 1 wt. % | 90 | 2.29 | 15-17 | 1.66 | 41.4 |
| hollow fiber | MEMBRANA | | | NaCl | | m/s | | | |
| membrane | | | | | | | | | |
| PVDF hollow | Lab-made | 122.9 | 1.5 | 3.5 wt. % | 80 | 0.5 | 20 | 0.1 | 61.9 |
| fiber | | | | NaCl | | L/min | | L/min | |
| membrane | | | | | | | | | |
| PVDF hollow | Lab-made | 145 | | 3.5 wt. % | 79.5 | 1.9 m/s | 17 | 0.9 m/s | 40.4 |
| fiber | | | | NaCl | | | | | |
| membrane | | | | | | | | | |
| PVDF-HFP | Lab-made | 74 | 1.81 | Caspian | 90 | 0.3 | 20 | 0.3 | 34.1 |
| hollow fiber | | | | Seawater | | L/min | | L/min | |
| membrane | | | | | | | | | |
| PVDF hollow | Lab-made | — | — | 3.5 wt. % | 79.3 | 1.6 m/s | 17.5 | 0.8 m/s | 41.5 ± 01.4 |
| fiber | | | | NaCl | | | | | |
| membrane | | | | | | | | | |
| PVDF hollow | Lab-made | 50 | — | 3.5 wt. % | 80 | 2.8 | 16-18 | 0.4 | 67 |
| fiber | | | | NaCl | | L/min | | L/min | |
| membrane | | | | | | | | | |
| PVDF hollow | Lab-made | 150 | 19.2 | 3.5 wt. % | 80.5 | 0.5 m/s | 20 | 0.15 | 46.3 |
| fiber | | | | NaCl | | | | m/s | |
| membrane | | | | | | | | | |
| PVDF flat | Lab-made | — | — | 3.5 wt. % | 70 | 180 | 15 | 60 | 27.4 |
| sheet | | | | NaCl | | L/min | | L/min | |
| membrane | | | | | | | | | |
| PVDF hollow | Lab-scale | 153 | 2.25 | 3.5 wt. % | 80 | 0.8 m/s | 20 | 0.6 m/s | 71.6 |
| fiber | | | | NaCl | | | | | |
| membrane | | | | | | | | | |

### Example 3: Prototype Model of Hollow Fiber Membrane

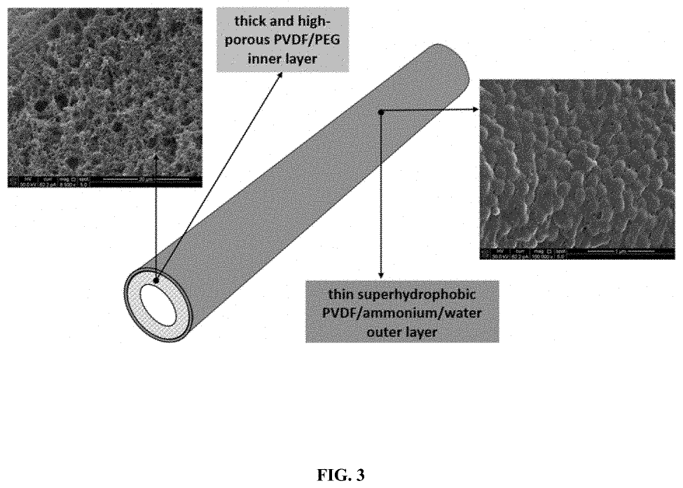

FIG. 3 illustrates a schematic drawing of a PVDF DCMD HFM. A membrane comprises a thin crosslinked superhydrophobic PVDF/ammonium/water outer layer and a thick high-porous PVDF/PEG inner layer.

### Example 4: PVDF/Si-R Dope Solutions for Hydrophobic HFM

A single-layer super hydrophobic PVDF/Si-R hybrid HFM was fabricated. The diameter of the PVDF/Si-R HFM was around 600 μm. Compared to a neat PVDF HFM, the water contact angle of the PVDF/Si-R hollow fiber membrane increased from 82° C. to 141° C. The increase indicated a significant hydrophobicity improvement of the PVDF/Si-R HFM. PVDF/Si-R HFM bundles, 2 inch diameter×36 inch length, was prepared using an epoxy-potting technique.

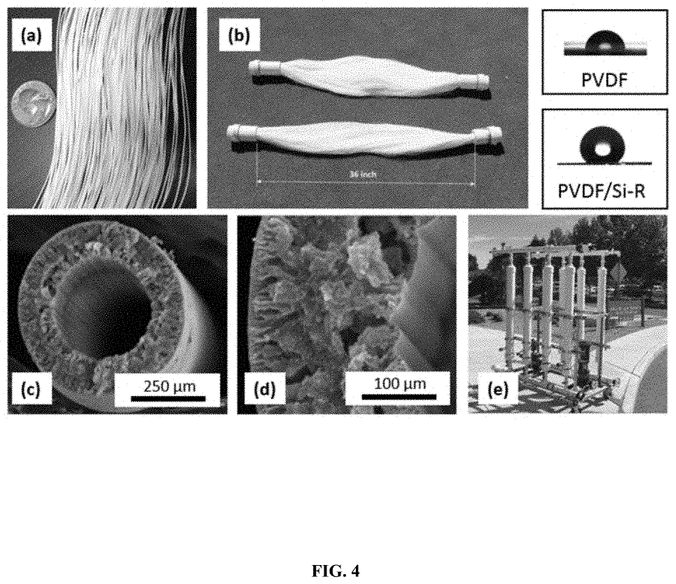

FIG. 4 PANEL A shows PVDF/Si-R HFMs. PANEL B shows PVDF/Si-R HFM bundles. PANEL C and PANEL D show cross-sectional SEM images of the PVDF/Si-R HFMs. PANEL E shows an example commercial stack.

### Example 5: Polyethersulfone and PVDF/Si-R Dual Layer HFM

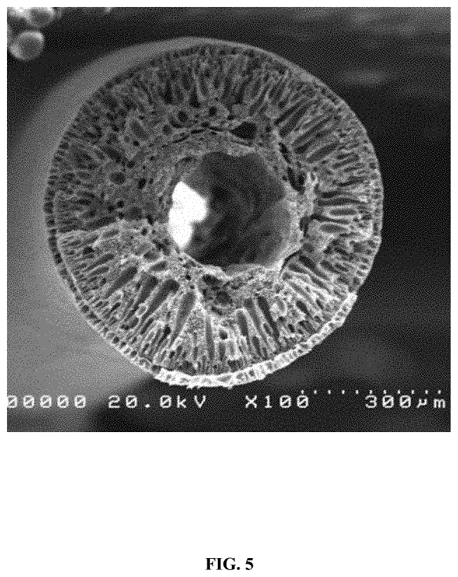

A polyethersulfone (PES) and PVDF/Si-R dual layer HFM was also fabricated. The PES/PVDF/Si-R dual-layer HFM consisted of a thick, porous, PES inner layer and a thin, PVDF/Si-R outer layer. No delamination was observed between the two layers. FIG. 5 shows the cross-sectional morphology of the PES/PVDF/Si-R dual-layer HFM.

### Example 6: PVDF-g-POEM Dope Solutions for CO₂-Philic Inner Layer of HFM

The membrane material for the CO₂-philic inner layer is prepared by blending PVDF with the CO₂-philic polymer, PEG. The ethylene oxide (EO) units of PEG are polar and induce dipole-quadrupole interactions towards CO₂. The interactions result in high CO₂ solubility and diffusivity. The presence of the PEG enhances CO₂ permeability in the thick PVDF/PEG inner layer. The enhanced permeability reduces CO₂ mass transfer resistance in the membrane contactor process. The compatibility between the PVDF/PEG inner layer and the PVDF/Si-R outer layer is improved during the co-extruding process, and was beneficial in forming a delamination-free PVDF/PEG and PVDF/Si-R dual layer HFM.

### Example 7: Formulation of Soybean-Based Solvent for CO₂ Capture in the Membrane Contactor Process

A stable, environmentally-friendly, and sustainable soybean-based (SBB) solvent was used as a CO₂ absorbent in the membrane contactor process. The SBB solvent was extracted from soybean seeds. The high protein content of soybean seeds was converted to various amino acid salts by reacting the soybean seeds with a strong base, such as potassium hydroxide or sodium hydroxide.

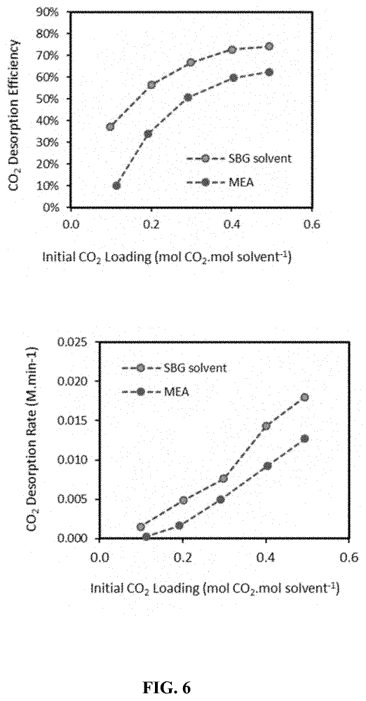

The SBB solvent exhibited comparable CO₂ absorption efficiency and CO₂ absorption rates with conventional amine (MEA) in a PVDF/Si-R HFM contactor process. The regeneration behavior of the SBB solvent was studied under different, initial CO₂ loadings to measure CO₂ desorption efficiency and CO₂ desorption rates. FIG. 6 PANEL A shows that the CO₂ desorption efficiency of the SBB solvent was 4 times greater than that of the MEA solvent at low CO₂ loadings. The CO₂ desorption efficiency was 12% higher than that of the MEA solvent at high CO₂ loadings. FIG. 6 PANEL B shows the CO₂ desorption rate of the SBB solvent. The CO₂ desorption rate of the SBB solvent was almost 50% faster than that of the MEA solvent. The regeneration energy consumed by the SBB solvent was 35% lower than the regeneration energy consumed by the MEA solvent.

TABLE 2 shows state-point data for the SBB solvent. The vapor pressure was less than 1.27×10⁻⁹ bar, and the equilibrium CO₂ loading was 0.232 gmol CO₂/kg SBB solvent. Since the major active components of the SBB solvent are amino acid salts, the SBB solvent was expected to exhibit enhanced compatibility with polymeric membranes, improved oxygen resistance, and increased CO₂ absorption capacity than the MEA solvent.

TABLE 2

| | | |
|---|---|---|
| | Measured/ | |
| | Estimated | Projected |
| Units | Performance | Performance |

Pure Solvent

| | | | |
|---|---|---|---|
| Molecular Weight | mol⁻¹ | 170.04 | 170.04 |
| Normal Boiling Point | ° C. | 244.54 | 244.54 |
| Normal Freezing Point | ° C. | 244.54 | 244.54 |
| Vapor | bar | <1.27 × 10⁻⁹ | <1.27 × 10⁻⁹ |
| Pressure @ 15° C. | | | |

Working Solution

| | | | |
|---|---|---|---|
| Concentration | kg/kg | 0.298 | 0.298 |
| Specific Gravity | — | 1.14 | 1.14 |
| (15° C./15° C.) | | | |
| Specific Heat | kJ/kg · K | 4.16 | 4.16 |
| Capacity @ STP | | | |
| Viscosity @ STP | cP | 3.33 | 3.33 |
| Surface | dyn/cm | 73.03 | 73.03 |
| Tension @ STP | | | |

Absorption

| | | | |
|---|---|---|---|
| Pressure | bar | 0.12 | 0.12 |
| Temperature | ° C.′ | 22 | 22 |
| Equilibrium CO₂ | gmol CO₂/kg | 4.18 | 4.18 |
| Loading | | | |
| Heat of Absorption | kJ/kg CO₂ | 2575.3 | 2575.3 |
| Solution Viscosity | cP | 3.58 | 3.58 |

Desorption

| | | | |
|---|---|---|---|
| Pressure | bar | 1 | 1 |
| Temperature | ° C. | 98.97 | 98.97 |
| Equilibrium CO₂ | gmol CO₂/kg | 0.22 | 0.22 |
| Loading | | | |
| Heat of Desorption | kJ/kg CO₂ | 2575.3 | 2575.3 |

### Example 8: Hollow Fiber Membrane for Direct Atmospheric CO₂ Capture

A membrane contactor process for direct atmospheric CO₂ capture is developed by integrating a CO₂-philic and super-hydrophobic dual-layer J-HFM with an environmentally friendly SBB solvent. The J-HFM is fabricated with a thick and porous CO₂-philic polymer with PEG with semi-crystalline PVDF inner layer and a thin super-hydrophobic PVDF-silica (Si-R) outer layer comprising silica nanoparticles (Si-R NPs). The CO₂-philic PVDF/PEG inner layer accelerates the CO₂ transfer rate and improves CO₂ capture efficiency. The super-hydrophobic PVDF/Si-R outer layer also improves long-term stability of the membrane contactor process.

A SBB solvent that contains 18 amino acid salts and absorbs CO₂ is developed for the membrane contactor process. The SBB solvent enhances CO₂ capture performance as measured by an increase in the CO₂ desorption rate and reduced solvent regeneration energy consumption. During the J-HFM-based membrane contactor process, air from the atmosphere is flowed through the CO₂-philic side of the J-HFM, while the SBB solvent is circulated on the super-hydrophobic side of the J-HFM.

The CO₂ capture performance of the J-HFM-based membrane contactor process is evaluated using atmospheric air under different operating conditions, such as relative humidity, flow rate, contaminant composition, operating temperature, and operating pressure. The regeneration behavior of the SBB solvent in the membrane contactor process is studied. The long-term stability of the J-HFM-based membrane contactor process is evaluated by measuring CO₂-capture efficiency, rate, capacity, long-term stability of the J-HFM and the SBB solvent, and energy consumption for SBB solvent regeneration. Environmental, safety, and techno-economic analysis are evaluated.

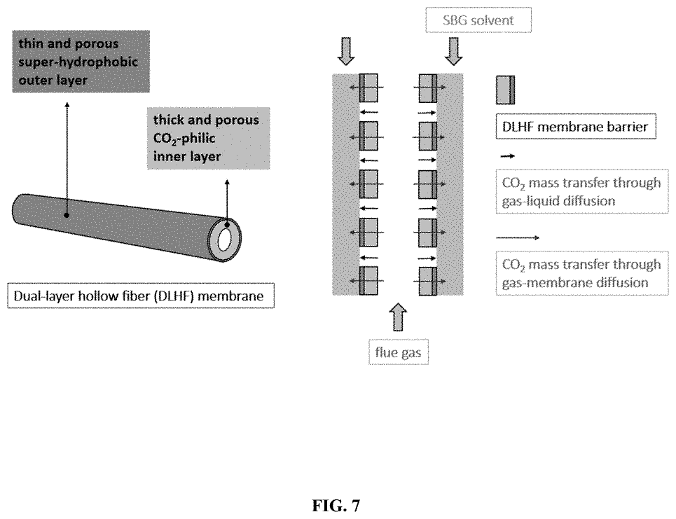

FIG. 7 illustrates the dual-layer J-HFM and the J-HFM contactor process using a SBB solvent as the CO₂ absorbent.

### Example 9: PVDF HFMs for Use in DCMD

Materials: Kynar® HSV 900 powder was used for membrane preparation. N-Methyl-2-Pyrrolidone (NMP), >99%) was used for the PVDF dope solution and bore fluid preparation. Ammonia (28%), PEG-6000 (>99.5%), sodium chloride (NaCl), and isopropyl alcohol (IPA) were purchased and used without purification. Pure kerosene was used for the membrane porosity measurements. The actual water sample produced was collected from Permian Basin, located at the southeast of New Mexico.

Crosslinked PVDF-based hydrophilic-hydrophobic dual-layer HFMs were fabricated for DCMD. A PVDF/ammonia/water dope solution was formulated with a spinning process delay of 9 days for the formation of a mechanically-robust and hydrophobic crosslinked PVDF outer layer. Polyethylene glycol 6000 (PEG-6000) was introduced to create a thick, hydrophilic, PVDF/PEG-6000 inner layer. The effects of ammonia/water contents and the use of spinning process delay on the membrane morphology were studied. The DCMD performance was investigated using both simulated seawater and actual oilfield produced water as the feed solution.

The incorporation of ammonia/water mixture allowed a slow PVDF crystallization in the dope solution during the period of the spinning process delay. The obtained membrane (DN2H2-9) showed contact angles of 133.6° and 47.1° on the surfaces of the crosslinked PVDF outer layer and PVDF/PEG-6000 inner layer, respectively. The membrane (DN2H2-9) showed a superior permeate water flux of 97.6 kg·m⁻²·h⁻¹ and an energy efficiency of 92.8% to desalinate a 3.5% NaCl solution. The result from a 200 hour, continuous DCMD operation revealed a stable permeate water flux and more than 99.9% of salt rejection, which was attributed to a relatively high liquid entry pressure (LEP) of 1.95 bar and the simultaneously-enhanced mechanical strength of the membrane. The membrane (DN2H2-9) also demonstrated promising DCMD performance in desalination of the real oilfield-produced water with a high total dissolved solids (TDS), including almost 100% of permeate water recovery and more than 99.9% of salt rejection in 72 hours of operation.

### Example 10: Dope Solution Preparation and Characterization

Dope solution preparation and characterization and hollow fiber membrane spinning: The PVDF and PEG-6000 powders were dried at 80° C. and 60° C. for 24 before the dope solution preparation, respectively. The dried polymer resin was dissolved in NMP under vigorous mechanical mixing at room temperature for 24 h. The PVDF concentrations of all the dope solutions were 12 wt %. The mixture of ammonia and water was then added to the dope solution in an ice bath to avoid heat-induced ammonia volatilization and overreaction of dehydrofluorination. The original 12 wt % PVDF/NMP dope solution was noted as D-P. Five different dope solutions with the mixture of ammonium and water were named as D-H4(PVDF/H₂O/NMP=12/4/84), D-N1H3 (PVDF/NH₄OH/H₂O/NMP=12/1/3/84), D-N2H2 (PVDF/NH₄OH/H₂O/NMP=12/2/2/84), D-N3H1 (PVDF/NH₄OH/H₂O/NMP=12/3/1/84), and D-N4 (PVDF/NH₄OH/NMP=12/4/84). The amount of the additive was fixed at 4 wt % in all the dope solution.

The dope solution DN2H2 was held for 9 days to allow a spinning process delay, and was then labeled D-N2H2-9. The dope solution for the inner layer formation was D-PEG-6000 (PVDF/PEG-6000/NMP=12/6/82). The prepared dope solutions were degassed in a vacuum oven for 12 hours before they were used for further dope characterization and membrane spinning.

The dope viscosity was characterized by cup and bob viscometer at room temperature, and the shear rate was 7.3 s⁻¹. The crystalline properties of the dope solutions were analyzed using differential scanning calorimetry. In the DSC measurement, approximately 10 mg of dope was used, and the test was performed at a heating rate of 5° C./min over the temperatures from 0 to 100° C.

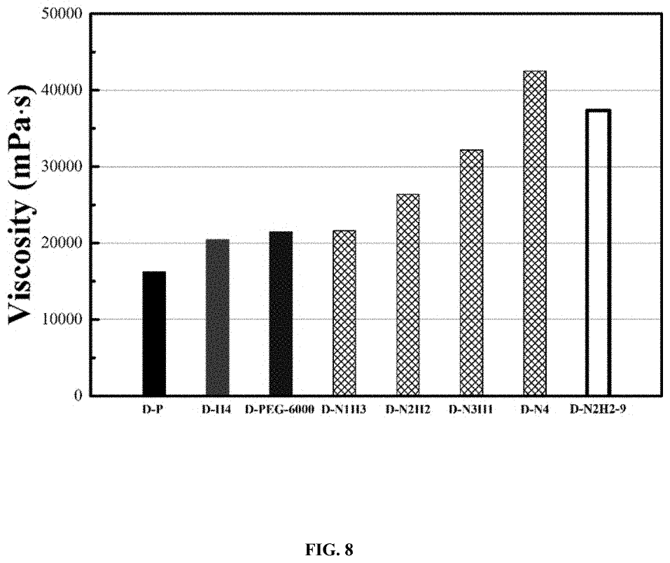

Dope solution properties: The rheological properties of the 12 wt % PVDF dope solutions prepared with different additives were demonstrated in FIG. 8. Compared to the original PVDF dope solution, the viscosity increased for all the dope solutions with the additives. For the dope solutions D-H4, D-PEG-6000, and D-N1H3, the viscosities were slightly increased compared to the dope solution D-P, and the incensement followed the order of D-N1H3>D-PEG-6000>D-H4>D-P. The dope solutions viscosities augmented with the increasing amount of the ammonium and water, and the dope solution D-N4 reached up to 42,502.6 mPa·s, which was about 2.5 times higher than the original dope solution D-P. The viscosity of the dope solution D-N2H2 increased from 26,362.3 mPa·s to 37,321.3 mPa·s after 9 days of the spinning process delay.

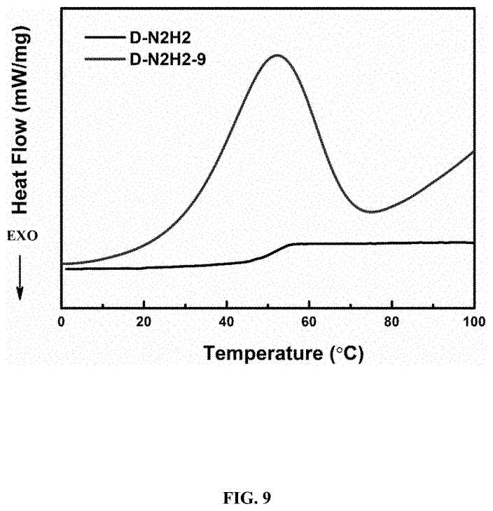

The higher viscosity of the dope solution D-N2H2-9 than that of D-N2H2 indicated slow PVDF crystallization. FIG. 9 shows an endothermic peak from the dope solution D-N2H2-9 on the DSC heating curve, and that the melting peak was at 52.3° C. The dope solution D-N2H2 showed a much weaker peak, which indicated that the crystallization was promoted during the 9 days of the spinning process delay. During the 9 days of spinning process delay, the crystallization took place slowly, and viscosity increased gradually.

### Example 11: Membrane Preparation

Flat-sheet membrane preparation: The effects of the ammonium and water amounts on the hydrophobicity of the crosslinked PVDF membrane were investigated before fabricating the HFM. The dope solution was first paved on a clean glass plate with a BYK-Gardner film casting knife, and the thickness was set at 250 μm. Then, the glass plate was placed at the bottle of a coagulant bath with different compositions. Specifically, the PVDF/PEG-6000 dope solution-based membrane was soaked in the coagulant bath with 70% NMP and 30% water for 3 days. The bath simulated the bore fluid used in the fabrication of the hollow fiber membrane. The PVDF/ammonium/water dope solution-based membranes were immersed in the coagulant bath containing only tap water. The flat-sheet membranes were obtained after 12 hours of freeze-drying in a Freeze Dryer.

HFM fabrication: The prepared bore fluids and dope solutions were transferred into three piston pumps and were extruded through a tri-orifice spinneret for the dual-layer hollow fiber membrane preparation. The dope compositions and spinning parameters for the membrane fabrication were tabulated. The spun dual-layer hollow fiber membrane without the spinning process delay was denoted as DH4 and DN2H2, and the membrane with 9 days of the spinning process design was DN2H2-9. Only the dope solution PVDF/ammonium/water for the outer layer formation was held for the spinning process delay, and the inner layer dope solution with PEG-6000 was used directly. A single-layer, virgin, PVDF, hollow fiber membrane was fabricated for comparison, and was named as SP. The spun fibers were immersed in tap water for 3 days and were dried in the Freeze Dryer for 12 hours. TABLE 3 shows the spinning parameters of the HFMs.

TABLE 3

| Membrane Code | SP | DH4 | DN2H2 | DN2H2-9 |
|---|---|---|---|---|
| Outer-layer dope | NA | PVDF/H₂O/ | PVDF/NH₄OH/H₂O/ | PVDF/NH₄OH/H₂O/ |
| composition (wt. %) | | NMP: 12/4/84 | NMP: 12/2/2/84 | NMP: 12/2/2/84 |
| Time for spinning | 0 | 0 | 0 | 9 |
| process delay (day) | | | | |
| Outer-layer dope flow | NA | 2 | 2 | 2 |
| rate (mL/min) | | | | |
| Inner-layer dope | PVDF/NMP: | PVDF/PEG-6000/ | PVDF/PEG-6000/ | PVDF/PEG-6000/ |
| composition (wt. %) | 12/88 | NMP:12/6/82 | NMP:12/6/82 | NMP:12/6/82 |
| Inner-layer dope flow | 4 | 2 | 2 | 2 |
| rate (mL/min) | | | | |
| Bore fluid composition | NMP/H₂O | NMP/H₂O | NMP/H₂O | NMP/H₂O |
| (wt. %) | (70/30) | (70/30) | (70/30) | (70/30) |
| Bore fluid flow rate | 2 | 2 | 2 | 2 |
| (mL/min) | | | | |
| External coagulant | Tap water | Tap water | Tap water | Tap water |
| Air gap (cm) | 3 | 3 | 3 | 3 |
| Take-up speed | Free fall | Free fall | Free fall | Free fall |

### Example 12: Membrane Characterization

Contact angle measurement: The contact angle (CA) of the PVDF flat-sheet membrane was tested with a Contact Angle Measurement System equipped with SCA20 software at room temperature. 5 μL of water was dropped on the membrane surface, and the contact angle was collected after 3 minutes. Five different points on the membrane surface were measured, and the average was recorded as the final result.

The CA measurements of hollow fiber membranes were performed using a tensiometer. Ten measurements were repeated for each membrane to ensure the measurement accuracy.

Membrane morphology: The morphologies of the hollow fiber membranes were observed with an FEI Quanta 200 3D DualBeam FIB/SEM system. The membrane sample was fractured in liquid nitrogen. Both the cross-sections and surfaces of the membranes were deposited with thin platinum utilizing a JEOL JFC-1300 coater.

The crystalline characteristics of the spun fibers were evaluated by an X-ray diffractometer (XRD), which was equipped with a Cu Kα radiation resource. The radiation source intensity, scanning range, and scanning rate were 40 kV/40 mA, 10° to 50°, and 2° min′, respectively. The crystallinities of the fibers were calculated via the deconvolution of the diffraction peaks method.

X-ray Photoelectron Spectroscopy (XPS) was employed to characterize the surface compositions of the hollow fiber membranes. The survey XPS spectra were scanned over the range of 0-1000 eV at the resolution of 1.0 eV. The high-resolution XPS scanning was also performed at a resolution of 0.1 eV for C1s.

Overall porosity, pore size, and effective porosity: The overall porosity of the hollow fiber membrane was measured by the kerosene immersion method. The dimensions and mass of the dry membrane sample were tested before the immersion of the membrane in kerosene solution for 5 days to make sure the bulk of the membrane was thoroughly wetted. The wet membrane sample was then taken out from the kerosene, and the residual kerosene on the surfaces of the membrane was wiped off with a tissue paper. The overall porosity was evaluated by Equation (1) as follows:

$$ɛ = \frac{4 ( {w}_{2} - {w}_{1} )}{π / ( {OD}^{2} - {ID}^{2} ) {ρ}_{k}} , \qquad ( 1 )$$

where ε is the overall porosity; w₁ and w₂ are the masses of the membrane before and after the kerosene immersion, respectively; 1 is the length of the hollow fiber membrane; OD and ID are the external and internal diameters of the membrane, respectively; and ρₖ is the density of kerosene. The average magnitude of 5 measurements was recorded as the final result.

The maximum pore diameter was evaluated with a bubble point method. The membrane sample was first soaked in IPA for 24 hours. Nitrogen was then introduced to the lumen side of the membrane to displace the IPA at gradually-increased trans-membrane pressure. The maximum pore size was estimated by the pressure that the first gas bubble was observed on the membrane's outer surface using the Laplace equation:

$${d}_{m} = \frac{4 σ}{Δ P} cos θ \qquad ( 2 )$$

where dₘ is the maximum pore size, a is the surface tension, θ is the contact angle of the liquid and membrane materials, and AP is the pressure difference across the membrane wall.

The mean pore size and effective porosity measurements were performed by following a gas permeation experiment. Briefly, a membrane module with an effective membrane length of 5 cm was assembled to measure the transmembrane gas permeation flux at different feed pressures. By plotting a linear curve between the gas permeance and pressure, the intercept (I₀) and slope (S₀) of the obtained curve could be used to estimate the mean pore size and effective porosity with the equations listed below.

$$\begin{matrix}{d}_{a} = \frac{16}{3} \frac{{S}_{0}}{{I}_{0}} {( \frac{8 RT}{π M} )}^{0.5} μ & ( 3 ) \\ {ɛ}_{e} = \frac{32 μ RT}{{d}_{p}^{2}} {S}_{0} & ( 4 )\end{matrix}$$

where dₐ is the mean pore size, εₑ is the effective porosity, R is the gas constant; T is the absolute temperature; M is the molecular weight of the gas; and μ is the gas viscosity.

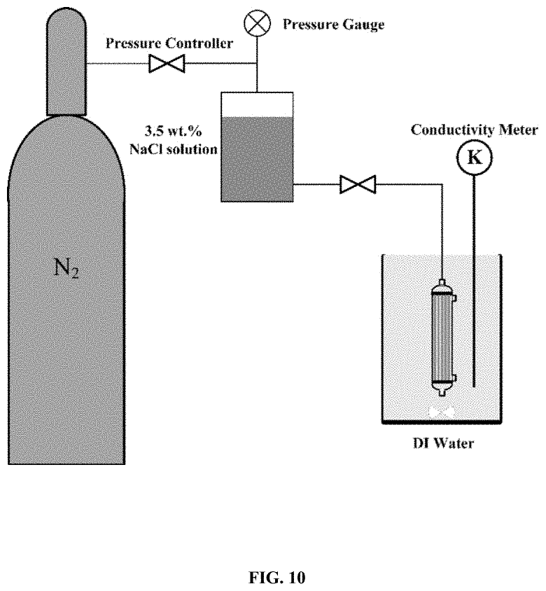

Liquid Entry Pressure (LEP): The LEP of the hollow fiber membranes was measured using the apparatus shown in FIG. 10. The membrane module was prepared with one end sealed using epoxy, and the other end was connected to a 3.5 wt. % brine solution, where the pressure was controlled by nitrogen equipped with a pressure regulator. During the LEP measurement, the whole membrane module was fully submerged in a DI water bath, and the pressure applied to the brine increased by 5 kpa every 10 minutes. The electrical conductivity of the DI water was monitored by a portable conductivity meter. When the electrical conductivity of the DI water changed sharply, the corresponding pressure was recorded as the LEP of the membrane.

Mechanical properties: The membrane's mechanical properties, which include Young's modulus and tensile strength were evaluated using MTS Criterion Model 44 tensile testing instruments at room temperature. The initial gauge length and testing speed were 5 cm and 5 cm/min, respectively.

Attenuated total reflection-Fourier transform infrared (ATR-FTIR): The chemical compositions on the outer surface of the hollow fiber membrane were investigated by a Fourier transform infrared (FTIR) spectroscopy with attenuated total reflectance (ATR). All spectra were recorded between 500 cm⁻¹ and 4000 cm⁻¹ with 32 scans at 1.0 cm⁻¹ spectral resolution.

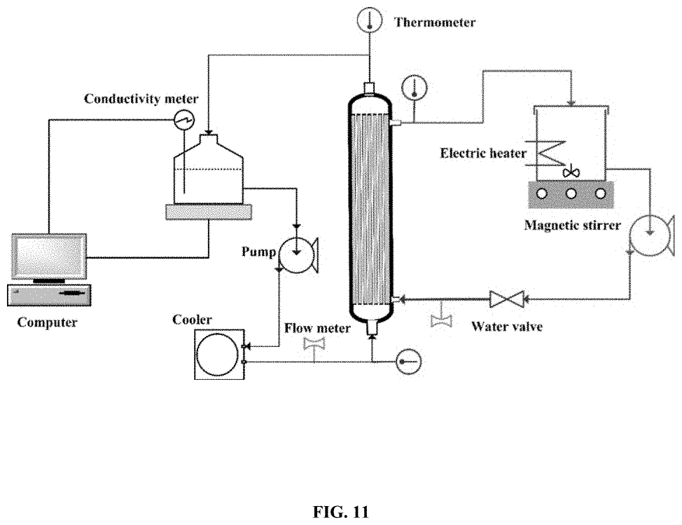

DCMD experiments: The DCMD experiments were conducted to evaluate the desalination performances of different membranes under various operating conditions. The HFM module was made of ten fibers, and both ends of the membrane bundle were sealed by high-temperature resistant epoxy resin. FIG. 11 shows the apparatus used for the DCMD experiments. The feed solution and permeate water temperatures were maintained by a water heater and a cooler, respectively. During the desalination process, the hot stream was introduced to the membranes' shell side, while the cold permeate water circulated along the lumen side of the hollow fiber membranes. The temperatures at the inlets and outlets of the hot and cold streams were recorded by four digital temperature transducers. The collected permeate water was weighted by a digital balance controlled by a data acquisition system, and the water mass increment was recorded every 20 seconds. The electrical conductivity and TDS of the recovered water were monitored by a conductivity/TDS meter. The permeation water flux, rejection efficiency, and energy efficiency were also calculated.

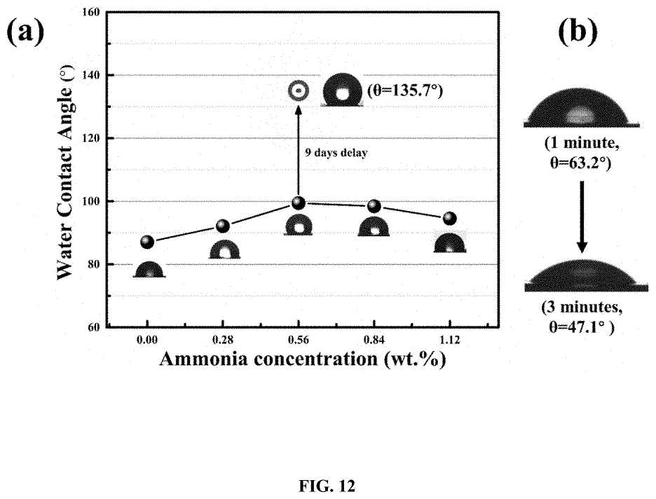

Influence of additives on flat sheet membrane hydrophobicity: FIG. 12 PANEL (a) presents the water contact angles of the membranes prepared with different ammonia and water concentrations. The total amount of the additives was fixed at 4 wt % in all the dope solutions. The use of ammonia and water slightly increased the hydrophobicity of the membrane, and the water contact angles ranged between 90° to 100°. Membrane hydrophobicity was not considerably influenced by the amount of ammonia in the dope solution. FIG. 12 PANEL (a) shows that the membrane D-N4 prepared with the maximum ammonia concentration showed a lower water contact angle than the membrane D-N2H2 with less ammonium.

The membrane D-N2H2-9 showed the highest contact angle. Considering the crystalline property of the dope solution D-N2H2-9, as confirmed by the DSC in FIG. 11, water-induced crystallization during the 9 days of spinning process delay was the major contributor to enhanced membrane hydrophobicity.

The contact angle of the flat-sheet membrane PVDF/PEG-6000 was also shown in FIG. 12 PANEL (b). The panel shows that a small water contact angle of 47.1° was observed after 3 minutes of the measurement on the surface of the membrane PVDF/PEG-6000. The measurement indicated the hydrophilic nature of the inner surface. The water contact angle on the membrane surface was 63.2° after 1 minute of the measurement, and was reduced to 47.1° after 3 minutes.

The use of non-solvents as additives was effective in improving membrane porosity but reduced membrane mechanical stability.

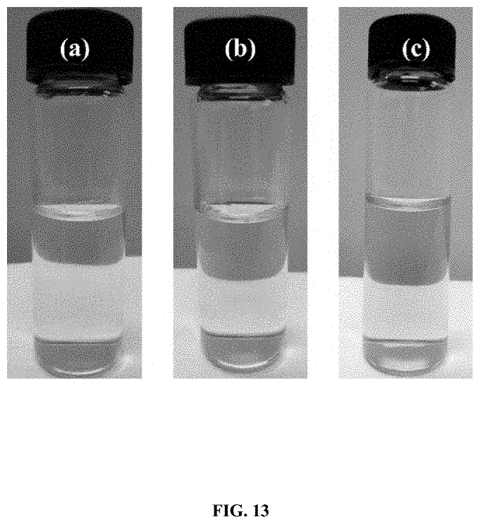

The dehydrofluorination was studied by observing the color change of the PVDF dope solution. As shown in FIG. 13, the virgin PVDF dope solution was colorless, but changed from light red-brown in the dope solution D-N2H2 to dark brown in D-N4. The color darkened when the amount of ammonium increased in the dope solution. The flat-sheet membrane D-N4 was stiff and fragile after completion of the reaction.

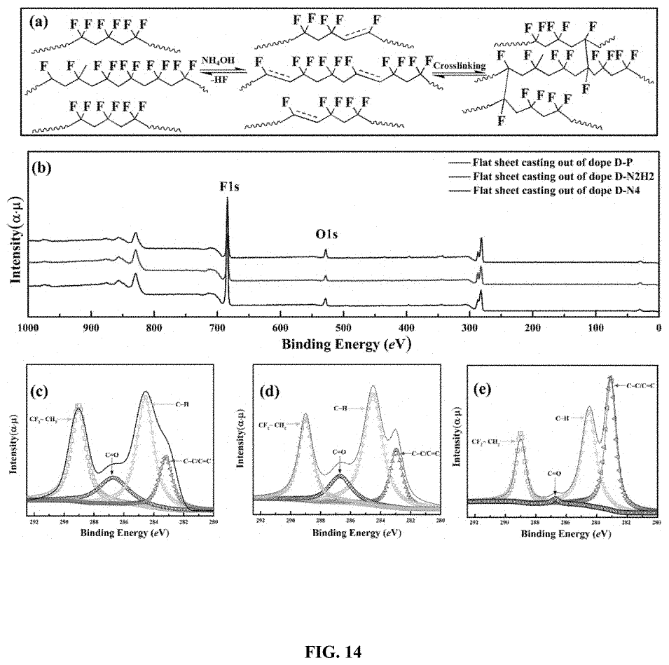

The chemical compositions on the membrane surface were examined by XPS, and the results are depicted in FIG. 14 PANEL (a)-PANEL (e). FIG. 14 PANEL (b) shows that two photoelectron peaks were observed at 680 and 285 eV in the XPS spectra. The peaks indicated that C and F were the two major elements on the membrane surface. However, the mass ratios of F/C on the surfaces of the membranes with ammonia were lesser than those observed for the membrane without ammonium. The declined F/C mass ratio can be explained by the loss of fluorine in the dehydrofluorination reaction, as indicated in FIG. 14 PANEL (a). TABLE 4 shows surface compositions of the neat and modified membranes.

TABLE 4

| Dope for casting flat | C | | | | | |
|---|---|---|---|---|---|---|
| sheet membrane | C—C/C═C | C—H | C═O | CF₂—CH₂ | F | O |
| D—P | 5.76 | 21.02 | 9.05 | 16.36 | 40.7 | 2.1 |
| D—N2H2 | 9.07 | 25.97 | 7.42 | 14.02 | 37.8 | 1.7 |
| D—N4 | 27.98 | 22.71 | 0.62 | 12.68 | 33.7 | 0.3 |

All units are at. %

FIG. 14 PANEL (c), (d), and (e) present high-resolution XPS spectra over C1s (280 eV-293 eV) of the three membrane samples. The C1s spectra shows the carbon atoms in terms of C—C/C═C (282.4 eV), C—H (284.5 eV), C═O (286.7 eV), and CF₂—CH₂ (289 eV). The carbon bonds of the neat D-P membrane were mainly C—H and CF₂—CH₂, while the membranes D-N2H2 and D-N4 exhibited enhanced carbon bond of C—C/C═C (289 eV), corresponding to the formation of new —F—C—C—H— bonds from the dehydrofluorination reaction. The carbon bond of C—C/C═C dominated the membrane structure as observed by the presence of ammonia of up to 1.12 wt % in the dope solution D-N4.

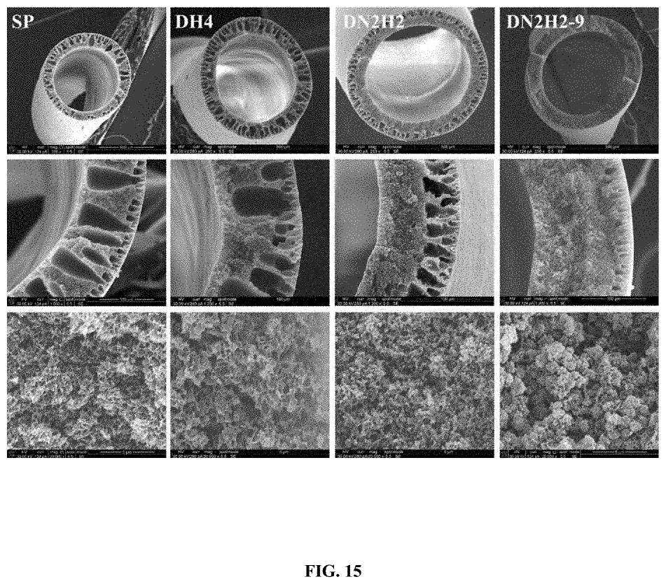

HFM morphology: FIG. 15 shows the cross-sectional morphologies of the hollow fiber membranes SP, DH4, DN2H2, and DN2H2-9. SP and DH4 exhibited similar macrovoid morphology. The finger-like macrovoids almost penetrated the whole sponge-like matrix, and many small macrovoids were observed under the outer skin surface. The dual-layer structure of the membrane DH4 was not apparent even as the spongy-like pores increased at the inner layer compared to the membrane SP. The high diffusion ability of water in the outer layer dope solution resulted in faster precipitation and quicker water intrusion. The accelerated water intrusion rate in the outer layer further influenced the precipitation of the inner layer dope solution and formed the big macrovoids at the whole cross-section of the membrane. The outer edges morphology of the membranes SP and DH4 are also illustrated in FIG. 15. Both membranes SP and DH4 showed a similar highly porous interconnected spongy-like pore structures.

DN2H2 exhibited a vividly asymmetric structure with a thick and macrovoids-free inner layer and a thin porous outer layer. The thicknesses of the inner and outer layers were 77 μm and 50 μm, respectively. The fully sponge-like inner layer of the membrane DN2H2 in FIG. 15 was attributed to the thermodynamic properties of the outer layer dope solution. The viscosity of the outer layer dope solution D-N2H2 was 26,362 mPa·s. This viscosity was significantly higher than that of the inner layer dope solution D-PEG-6000, due to the ammonium induced PVDF molecular chains cross-linking via the dehydrofluorination reaction. The high outer layer dope viscosity prevented the water intrusion from the coagulant bath. This prevention also reduced the solvent exchange rate in the phase inversion process. The outer edge of the membrane DH2N2 showed a similar interconnected pore structure as the membranes SP and DH4. However, the big macrovoids were still observed underneath the outer skin surface, where a mechanical weakness point can occur. This point was found to aggravate the membrane-wetting in DCMD.

D-N2H2-9 showed a distinct cross-sectional morphology from the membrane D-N2H2. FIG. 15 shows that the finger-like macrovoids in the membrane D-H2N2 disappeared across the entire cross-section of the membrane D-N2H2-9 with 9 days of spinning process delay. D-N2H2-9 showed a macrovoid-inhibited membrane morphology with only small pyriform-like pores present under the outer surface.

The outer edge of the membrane D-H2N2-9 is also depicted in FIG. 15. Large numbers of porous, spherulitic globules were packed beneath the outer surface, and the diameters of the spherulites were around 1.3-1.7 μm. The spherulitic globules in the membrane DN2H2-9 had a highly porous, spherulitic structure and were less inter-connected among the spherulitic globules. The lessened interconnection contributed to a lessened mass transfer resistance in DCMD.

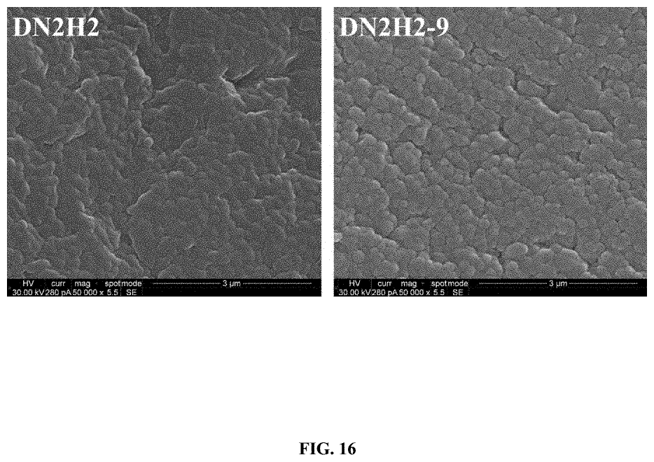

FIG. 16 illustrates the outer surface morphologies of the membranes DN2H2 and DN2H2-9. The surfaces of the two membranes were both composed of spherulitic crystals with a high packing density. Nonetheless, the packing of crystals was looser and more uniform on the outer surface of the membrane DN2H2-9. The small gaps that appeared among the isolated crystals contributed to the bigger pore size and higher membrane surface roughness. The evenly-distributed spherulitic structure contributed to the high membrane surface hydrophobicity of the membrane DH2N2-9.

### Example 13: HFM Properties

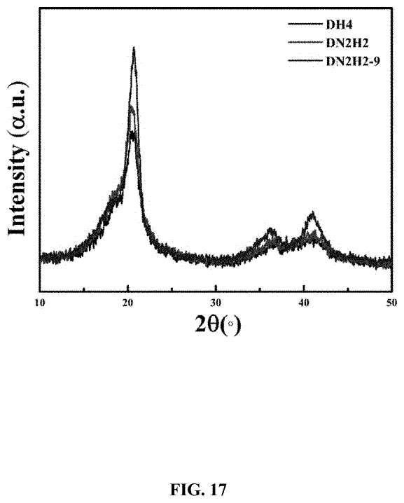

The crystallization behaviors of the dual-layer HFMs were investigated with the XRD. As illustrated in FIG. 17, all the membranes showed similar diffraction peaks with different intensities. The peaks at 18.4° and 20.6° represented the a and y crystalline phases, respectively, and the weak diffraction peaks at 36.5° and 40.7° corresponded to the crystalline phase of PVDF. The peak intensities of the membranes declined following the order of DN2H2-9>DN2H2>DH4. The membrane DN2H2-9 exhibited the highest crystallinity. Crystallization plays a role in the phase inversion process.

The hollow fiber membrane properties, including dimensions, porosity, mean pore size, maximum pore size, water contact angle, and LEP, were tabulated. The outer diameter (OD) and wall thickness (WT) of the hollow fiber membranes decreased following the order of DN2H2-9>DN2H2>DH4>SP. This order was in accordance with the dope viscosity. TABLE 5 shows properties of single and dual-layer hollow fiber membranes.

TABLE 5

| | | Bulk | | | Bubble point | | |
|---|---|---|---|---|---|---|---|
| | Average | Porosity (ε, | Effective surface | Mean pore size | pore size (dₘ, | Contact Angle | LEP |
| No. | OD/ID/WT (μm) | %) | porosity (εₑ, m⁻¹) | (dₐ, μm) | μm) | (CA, °) | (bar) |
| SP | 788/580/104 | 64.4 ± 0.8 | 1762.5 | 0.08 | 0.27 | 87.4 ± 0.4 | 1.15 |
| DH4 | 907/669/119 | 84.3 ± 0.6 | 3247.8 | 0.22 | 0.30 | 92.7 ± 1.1 | 0.75 |
| DN2H2 | 1037/783/127 | 81.3 ± 0.7 | 4314.5 | 0.19 | 0.34 | 106.7 ± 3.1 | 0.95 |
| DN2H2- | 1088/767/135 | 80.6 ± 0.4 | 6471.3 | 0.27 | 0.40 | 133.9 ± 1.8 | 1.95 |
| 9 | | | | | | | |

The bulk porosity of the virgin membrane SP was 64.4±0.9%, and was 80-85% for all the dual-layer HFMs. The membrane DH4 showed the highest bulk porosity of 84.3±2.4%, showing that adding PEG-6000 in the inner layer dope solution and maximizing water content in the outer layer dope solution both promoted the formation of the pores in the membrane. The addition of ammonia to the dope solution slightly decreased the porosity of the membrane DN2H2 compared to the membrane DH4. This result was consistent, with lesser macrovoid percentages at the cross-section of the membrane. The spinning process delay slightly reduced the bulk porosity of the membrane DN2H2 from 82.3±1.7% to 80.6±0.4% due to the formation of the globule structure of the membrane DN2H2-9. The effective porosity of the membrane DN2H2-9 reached up to 6,471.3 m⁻¹, much higher than did the membrane DN2H2. The high effective porosity indicated less mass transfer resistance and the associated high permeate water flux in DCMD.

The membrane's mean pore size and maximum pore size are relevant for evaluating the DCMD performance, especially the permeate water flux and membrane-wetting phenomenon. As shown in TABLE 5, the mean pore sizes and maximum pore sizes of the membranes DH4 and DN2H2 were much larger than that of the membrane SP. The mean pore size and maximum pore size of the membrane DN2H2-9 reached to 0.27 μm and 0.40 μm, respectively.

Anti-wetting ability of a membrane can be used to evaluate the long-term application potential of a newly-developed membrane. The LEP magnitude can be used as an indicator for the membrane's anti-wetting ability. Since the LEP is mainly estimated from the membrane surface pore size and hydrophobicity based on the Young-Laplace equation, the tailoring of pore size and enhancement of membrane hydrophobicity was essential to pursue the membranes with high anti-wetting ability. The water contact angle of the membrane DN2H2-9 was 133.9±1.8°. This angle corresponds to the increased membrane surface roughness. The contact angles of the obtained HFMs were consistent with that of the flat-sheet membranes of FIG. 12. The inner surface hydrophilicity of the dual-layer hollow fiber membrane was estimated by the flat-sheet membrane, and the contact angle was 47.1°.

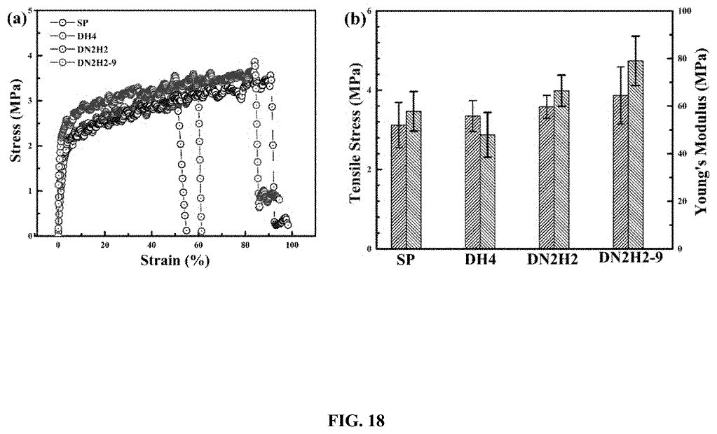

FIG. 18 illustrates the membrane mechanical properties with regards to the stress-strain curve, tensile stress, and Young's modulus. As shown in FIG. 18 PANEL (a), the membranes with the mixture of ammonia and water, DN2H2 and DN2H2-9, exhibited an improvement in overall mechanical strength compared to the original membrane SP. The increase was indicated by the increased strain and stress at break. Both the elongation at break and maximum stress of the membranes DN2H2 and DN2H2-9 were much higher than those of SP and DH4. This observation was attributed to the dehydrofluorination reaction that resulted in the cross-linking of the PVDF macromolecules.

FIG. 18 PANEL (b) plotted the tensile strength and Young's modulus of the spun HFMs. Compared to the virgin membrane SP, the membrane DH4 showed a lower Young's modulus but a slightly higher tensile stress. The reduction of Young's modulus was caused by the presence of big macrovoids across the membrane matrix. The membrane DN2H2-9 exhibited the highest tensile strength and Young's modulus. The increments in Young's modulus were 36.5%, 64.9%, and 18.9% compared to those of the membrane SP, DH4, and DN2H2, respectively. The results indicated that both the ammonium induced cross-linking of the PVDF macromolecules and the occurrence of PVDF crystallization helped the mechanical properties enhancement for the hollow fiber membranes.

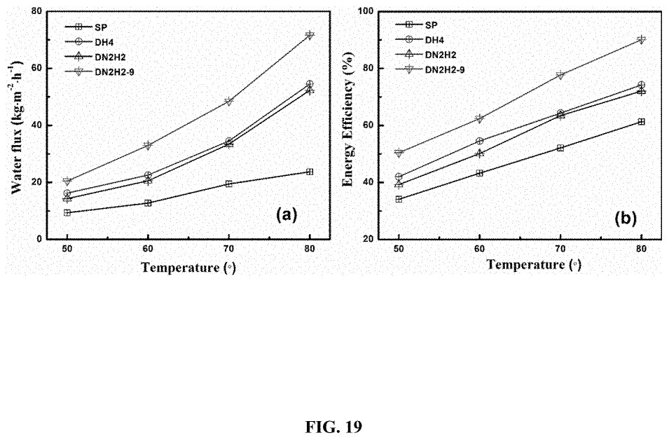

DCMD Performance: The DCMD performances of both the single-layer and dual-layer hollow fiber membranes were evaluated with regards to permeate water flux and energy efficiency (EE). The feed temperatures of the 3.5 wt % NaCl varied from 50° C. to 80° C., and permeate temperature was maintained at 20° C. The flow velocities were 0.8 m/s and 0.6 m/s at the feed and permeate sides, respectively. FIG. 19 exhibits the water flux and EE of the membranes in 30 minutes of DCMD experiments. The water conductivity at the permeate side was lower than 4 μS/cm for all the four membranes, corresponding to more than 99.99% of salt rejection.

FIG. 19 shows that the dual-layer membranes demonstrated much higher water flux and energy efficiency than did the single-layer membrane SP. The dual-layer membranes contained a highly-porous hydrophilic inner layer with a mean thickness of 77 μm. This thickness reduced the vapor transfer resistance, and maintained a simultaneously-high heat transfer resistance to avoid the conductive heat loss through the membrane matrix. Among all the dual-layer hollow fiber membranes, the membrane DN2H2-9 showed the highest water flux and energy efficiency of 71.66 kg·m⁻²·h⁻¹ and 90.1%, respectively. The synchronous enhancement of water flux and energy efficiency was ascribed to the increased effective porosity and enlarged pore size.

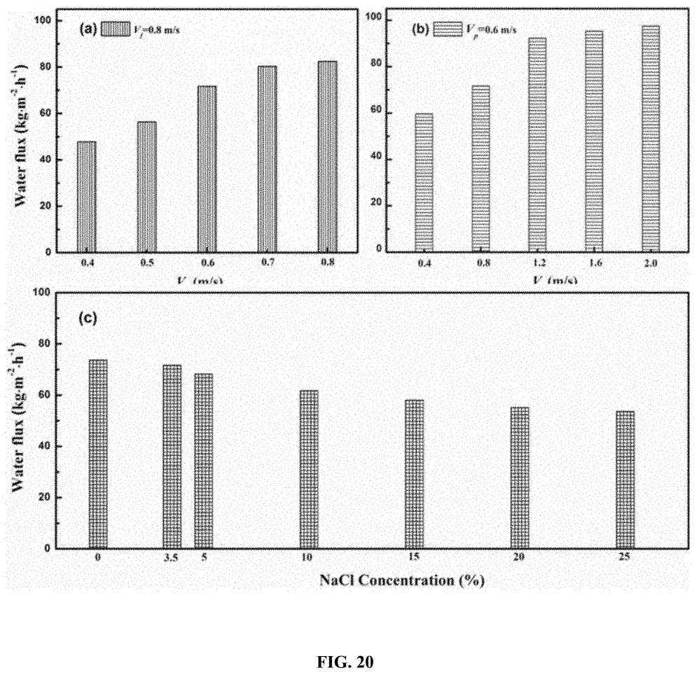

FIG. 20 panel (a)-(c) shows the performance of a hollow fiber membrane of the disclosure in desalinating super-high salinity water (100,000-250,000 mg/L). The effect of the feed solution velocity (V_{f}) and permeate water velocity (Vₚ) are illustrated in FIG. 20 PANEL (a) and PANEL (b), respectively. The temperatures were fixed at 80° C. and 20° C. at the feed and permeate sides, respectively. The rejection was higher than 99.9% for all the DCMD experiments. This level resulted from the enhanced outer surface hydrophobicity of the membrane DN2H2-9. The permeate water in FIG. 20 increased with the increasing feed and permeate water velocities. Specifically, as the Vₚ increased from 0.4 to 0.8 m/s and the V_{f} was fixed at 0.8 m/s, the water flux raised from 47.77 to 82.44 kg·m⁻²·h^{·1}. Similarly, as the V_{f} increased from 0.4 m/s to 2.0 m/s and the Vₚ remained at 0.6 m/s, the water flux improved from 59.71 to 97.6 kg·m⁻²·h⁻¹. The highest energy efficiency was 92.8% when the Vₚ and V_{f} were 0.6 and 2.0 m/s, respectively. The temperature polarization decreased with both the increasing V_{f} and Vₚ. The higher linear velocities decreased the thickness of the thermal boundary layer across the membrane and promoted the vapor transfer in DCMD.

FIG. 20 PANEL (a) and PANEL (b) also show that the water flux improved slightly when the Vₚ and V_{f} were more than 0.7 and 1.2 m/s, respectively. For instance, the permeate water flux sharply increased from 47.77 to 71.66 and 80.32 kg·m⁻²·h⁻¹ when the Vₚ increased from 0.4 to 0.6 and 0.7 m/s, respectively. Afterward, the water flux slightly increased from 80.32 to 82.44 kg·m⁻²·h⁻¹ as the Vₚ further increased from 0.6 to 0.8 m/s. The permeate water flux was more sensitive to the velocity at the permeate side than that at the feed side. The thickness change of the thermal boundary layer resulted in the hydrophilic inner layer being much easier to penetrate under a higher hydraulic pressure induced by the increased flow velocity at the permeate side. Once the hydrophilic inner layer was fully wet, the thickness of the thermal boundary layer was mainly determined by the thickness of the hydrophobic layer, and thus the permeate water flux was not sensitive to the further incensement of the permeate water velocity in DCMD.

One of the advantages of the DCMD over the conventional pressure-driven membrane-based desalination technologies is that the DCMD can remediate high salinity brine without being detrimental to the water quality at the permeate side. FIG. 20 PANEL (c) illustrates the effect of feed salinity on the DCMD performance of the hydrophilic-hydrophobic dual-layer HFM DN2H2-9. The feed salinity increased from 0 to 25 wt %, and the permeate water flux declined gradually. The reduced vapor partial pressure at the hot feed side resulted from the decreased water activity caused by the hydration of ions and ionic association in the feed solution with higher salinity. The driving force was reduced in DCMD. The permeate water flux remained higher than 50 kg·m⁻²·h⁻¹ for the feed solution with the salinity of 25 wt %. The result indicated that the membrane DN2H-9 shows potential in desalinating the emerging wastewater with super-high salinities, such as the oilfield-produced water and the concentrate stream from the reverse osmosis (RO).

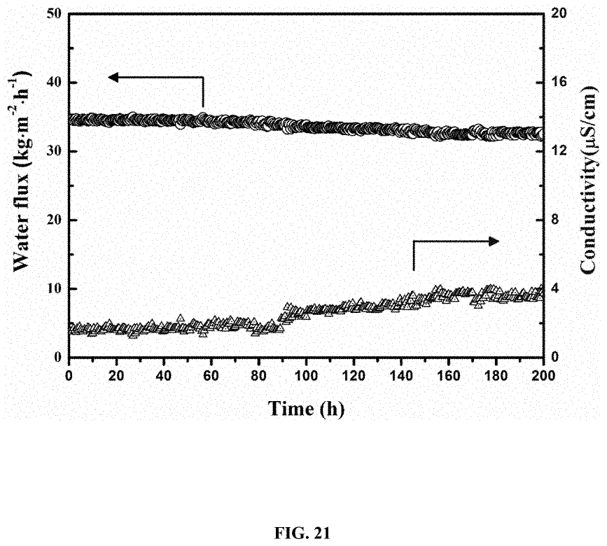

The long-term membrane performance was evaluated over 200 hours of continuous DCMD operation by using 3.5 wt % brine solution. The temperatures and flow velocities at the feed and permeate sides were 60° C. and 20° C., and 0.8 m/s and 0.6 m/s, respectively. FIG. 21 illustrates the water flux and permeate water conductivity in the 200 hours experiment. The membrane DN2H2-9 possessed stable permeate water flux and permeate water conductivity during the whole desalination process. FIG. 21 shows that the initial permeate water flux was 34.7 kg·m⁻²·h⁻¹, and a slight flux decline was observed at the operating time of 90 hours. The decrease can be explained as the salt crystal precipitation induced salt scaling on the membrane surface.

As indicated in FIG. 21, the water flux remained at 32.9 kg·m⁻²·h⁻¹ after the 200 hours operations. The overall water flux declined only 5.2% after 200 hours of DCMD operation. The electrical conductivity of the collected permeate water was kept lesser than 40/cm after 200 hours of operation. This value corresponded to more than 99.99% salt rejection in DCMD. The observation corresponds to the enhanced membrane surface hydrophobicity and the associated high LEP.

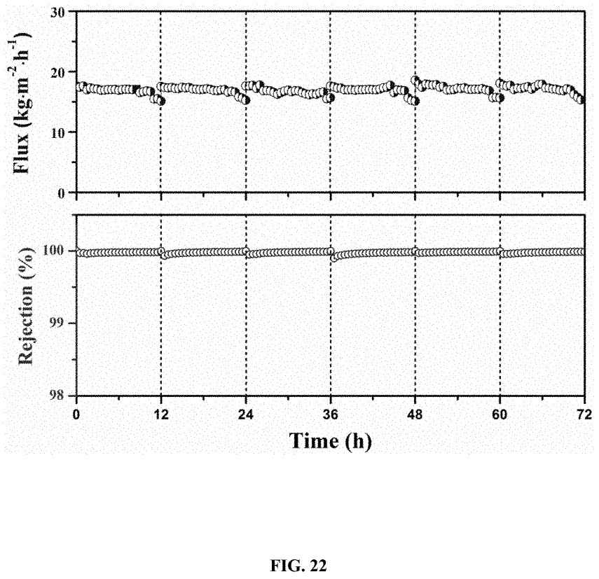

FIG. 22 shows water flux and rejection of the dual-layer HFM DN2H2-9 for desalination of real oilfield-produced water. The TDS and non-purgeable organic carbon (NPOC) were 154,220 mg/L and 57.6 mg/1, respectively. During the DCMD experiment, the temperatures of the feed solution and permeate water were 60° C. and 20° C., respectively. The velocities of both streams were 0.4 m/s. The membrane DN2H2-9 was flushed at 2.0 m/s every 12 hours using DI water and was then dried for the next 12 hours operation. The results in FIG. 22 show that the membrane DN2H2-9 exhibited very similar desalination performance in 6 cycles of the DCMD operation. The permeate water flux at each cycle slightly decreased from 17.5 kg·m⁻²·h⁻¹ to 16.5 kg·m⁻²·h⁻¹ after around 10 hours of operation, and was then quickly reduced to 15.1 kg·m⁻²·h⁻¹ after 12 hours operation. The salt rejection of the whole desalinating process was higher than 99.99%. The data show that the hollow fiber membrane of the disclosure exhibited super-stable performance in long-term desalination of oilfield-produced water, as demonstrated by the near-complete salt rejection, stable water flux, and high regeneration ability.

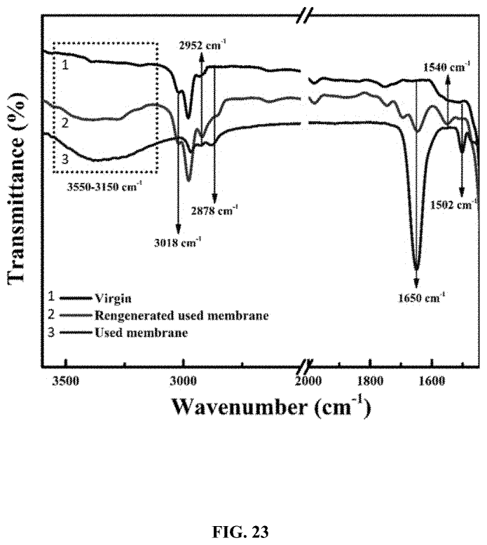

The slight deterioration of water flux in FIG. 22 could be attributed to the membrane surface fouling caused by the dissolved organics or inorganic salts from the produced water. FIG. 23 shows ATR-FTIR of the fresh, used, and regenerated membrane DN2H2-9. Compared to the virgin membrane, four new peak bands located at 1580 cm⁻¹ to 1500 cm⁻¹, 1650 cm⁻¹, 2960 cm⁻¹ to 2850 cm⁻¹, and 3500 cm⁻¹ to 3200 cm⁻¹ were found for the used membrane after 12 hours operation. The bands contributed to COO⁻ and N—H deformation, aromatic hydrocarbons/carbonate, aliphatic hydrocarbon, and O—H stretch, respectively. The characteristic peak of PVDF at 2983 cm⁻¹ has defaulted as a reference for the comparisons. The most substantial peak located at 1650 cm⁻¹ indicated the carbonate scale formation. A relatively low permeate water flux was designed for the produced water desalination. The hydraulic pressure applied to the outer surface of the membrane was limited by a low feed velocity of 0.4 m/s. FIG. 23 shows that most of the organics and carbonate scales were significantly reduced after the high-velocity physical flushing process, as indicated by the weak vibration signals in the FTIR spectra.

Although the membrane fouling and scaling were difficult to eliminate completely in the physical flushing process, the membrane showed almost 100% permeate water flux recovery and more than 99.9% salt rejection during all the 5 cycles of the DCMD operation. The membrane DN2H2-9 contained a macrovoids-free outer layer and a highly hydrophobic outer surface in the water-induced crystallization dominated membrane formation process. The uniform pore structure inhibited the migration of the foulants and scales to the membrane bulk in 12 hours of operation. The relatively big pore size facilitated the removal of the foulants and scales from the membrane surface. Ammonium-induced PVDF macromolecules cross-linking improved the membrane mechanical strength, which helped to ensure a constant pore geometry without any deformation in the high-velocity flushing process from membrane regeneration.

### Example 14: Conclusions

PVDF-based hydrophilic and hydrophobic dual-layer hollow fiber membranes were fabricated with a thick and hydrophilic PVDF/PEG-6000 inner layer and a thin hydrophobic crosslinked PVDF outer layer. Both mechanical strength and hydrophobicity of the hydrophobic PVDF outer layer were improved by the use of ammonium and water as the additive under 9 days of the spinning process design. The addition of ammonium and water to the PVDF outer layer dope solution resulted in the crosslinking of PVDF macromolecules and enhanced the membrane's mechanical strength. The allowance of 9 days of spinning process delay promoted the PVDF crystallization and inhibited the formation of macrovoids in the membrane. Both the ammonium induced crosslinking and water induced crystallization increased the membrane surface roughness, and significantly enhanced the hydrophobicity of the function layer of the membrane. The membrane DN2H2-9 showed desirable membrane properties for DCMD, including high effective porosity, relatively high LEP magnitude, large mean pore size, good mechanical strength, and improved membrane surface hydrophobicity with the water contact angle of 133.6°. The membrane DN2H2-9 exhibited encouraging DCMD performance in desalination of both simulated seawater and actual oilfield produced water. The permeate water flux and energy efficiency reached up to 97.6 kg·m⁻²·h⁻¹ and 92.8% when 3.5% NaCl was used as the feed solution, respectively. Stable permeate water flux and higher than 99.9% of salt rejection in DCMD desalination of both the seawater and oilfield produced water were observed. The results of this study provided a facile approach for the fabrication of the PVDF-based hydrophobic-hydrophobic dual-layer hollow fiber membranes that could be effectively used to desalinate different types of wastewater.

### Example 15: Desalination Performance of Membranes

Water samples were obtained from various locations in New Mexico, USA. Produced water is water trapped in underground formations that is brought to the surface during oil and gas exploration and production. Produced water from Huerfano 510, Canyon 19H, P.O. Pipkin 6F, and Canyon Largo 450 were desalinated using a hollow fiber membrane of the disclosure. The data show that the membranes had salt rejection percentages of greater than 99.7% in all locations.

TABLE 6

| Produced | Huerfano | Canyon | P.O. Pipkin | Canyon |
|---|---|---|---|---|
| Water (PW) | 510 | 19H | 6F | Largo 450 |
| Initial TDS (mg/L) | 51,020 | 19,160 | 12,402 | 14,483 |
| Flux (kg/m2/h) | 18.7 | 18.4 | 18.0 | 16.4 |
| Salt Rejection (%) | >99.93 | >99.75 | >99.90 | >99.96 |
| Water Recovery (%) | 70.3 | 81.7 | 73.4 | 84 |

### EMBODIMENTS

The following non-limiting embodiments provide illustrative examples of the invention, but do not limit the scope of the invention.

Embodiment 1. A composition comprising a fiber, wherein the fiber comprises: a) an inner layer, wherein the inner layer comprises a fluoropolymer, wherein the inner layer has a tubular shape, wherein the inner layer further comprises an inner surface and an outer surface; and b) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber.

Embodiment 2. The composition of embodiment 1, wherein the fiber further comprises a first end and a second end, wherein the first end is an inlet and the second end is an outlet, wherein the inlet is configured to allow passage of a fluid into the tubular channel, and the outlet is configured to allow passage of the fluid out of the tubular channel.

Embodiment 3. The composition of embodiment 1, wherein the inner layer is a hollow fiber membrane.

Embodiment 4. The composition of embodiment 1 or 2, wherein the fluoropolymer is a thermoplastic fluoropolymer.

Embodiment 5. The composition of any one of embodiments 1-4, wherein the fluoropolymer is polyvinylidene fluoride (PVDF).

Embodiment 6. The composition of any one of embodiments 1-4, wherein the fluoropolymer is ethylene chlorotrifluoroethylene (ECTFE).

Embodiment 7. The composition of any one of embodiments 1-4, wherein the fluoropolymer is perfluoroalkoxy (PFA).

Embodiment 8. The composition of any one of embodiments 1-4, wherein the fluoropolymer is fluorinated ethylene propylene (FEP).

Embodiment 9. The composition of any one of embodiments 1-8, wherein the inner layer further comprises polyethylene glycol (PEG).

Embodiment 10. The composition of any one of embodiments 1-9, wherein the inner layer comprises about 10% (wt %) of PEG.

Embodiment 11. The composition of any one of embodiments 1-9, wherein the inner layer comprises about 20% (wt %) of PEG.

Embodiment 12. The composition of any one of embodiments 9-11, wherein the PEG is PEG-4000.

Embodiment 13. The composition of any one of embodiments 9-11, wherein the PEG is PEG-6000.

Embodiment 14. The composition of any one of embodiments 9-11, wherein the PEG is PEG-8000.

Embodiment 15. The composition of any one of embodiments 1-14, wherein the inner layer has a mean thickness of from about 50 μm to about 250 μm.

Embodiment 16. The composition of any one of embodiments 1-15, wherein the inner layer has a mean thickness of about 135 μm.

Embodiment 17. The composition of any one of embodiments 1-16, wherein the inner layer is porous and has a mean pore size of from about 0.15 μm to about 0.4 μm.

Embodiment 18. The composition of any one of embodiments 1-17, wherein the inner layer is porous and has a mean pore size is about 0.27 μm.

Embodiment 19. The composition of any one of embodiments 1-18, wherein the inner layer is porous and has a maximum pore size of from about 0.3 μm to about 0.5 μm.

Embodiment 20. The composition of any one of embodiments 1-19, wherein the inner layer is porous and has a maximum pore size of about 0.4 μm.

Embodiment 21. The composition of any one of embodiments 1-20, wherein the inner layer has a percentage of void space of from about 75% to about 95%.

Embodiment 22. The composition of any one of embodiments 1-21, wherein the inner layer has a percentage of void space of about 80%.

Embodiment 23. The composition of any one of embodiments 1-22, wherein when the inner layer is placed on a surface, the inner layer forms an angle between the surface and a line tangent to the edge of the inner layer of from about 0° to about 90°.

Embodiment 24. The composition of any one of embodiments 1-23, wherein when the inner layer is placed on a surface, the inner layer forms an angle between the surface and a line tangent to the edge of the inner layer of about 47°.

Embodiment 25. The composition of any one of embodiments 1-24, wherein the inner layer has a tensile strength of at least about 2 MPa.

Embodiment 26. The composition of any one of embodiments 1-25, wherein the inner layer has a tensile strength of at least about 3.5 MPa.

Embodiment 27. The composition of any one of embodiments 1-26, wherein the inner layer has a tensile strength of at least about 3.8 MPa.

Embodiment 28. The composition of any one of embodiments 1-27, wherein the inner layer has a Young's modulus of at least about 70 MPa.

Embodiment 29. The composition of any one of embodiments 1-28, wherein the inner layer has a Young's modulus of at least about 75 MPa.

Embodiment 30. The composition of any one of embodiments 1-29, wherein the inner layer has a Young's modulus of at least about 79 MPa.

Embodiment 31. The composition of any one of embodiments 1-30, wherein the outer layer is hydrophobic.

Embodiment 32. The composition of any one of embodiments 1-31, wherein the polyvinylidene is PVDF.

Embodiment 33. The composition of any one of embodiments 1-32, wherein the outer layer has a mean thickness of from about 0.1 μm to about 200 μm.

Embodiment 34. The composition of any one of embodiments 1-33, wherein the outer layer has a mean thickness of about 100 μm.

Embodiment 35. The composition of any one of embodiments 1-34, wherein the outer layer is porous and has a mean pore size of from about 0.15 μm to about 0.4 μm.

Embodiment 36. The composition of any one of embodiments 1-35, wherein the outer layer is porous and has a mean pore size is about 0.3 μm.

Embodiment 37. The composition of any one of embodiments 1-36, wherein the outer layer is porous and has a maximum pore size of from about 0.3 μm to about 0.5 μm.

Embodiment 38. The composition of any one of embodiments 1-37, wherein the outer layer is porous and has a maximum pore size of about 0.4 μm.

Embodiment 39. The composition of any one of embodiments 1-38, wherein the outer layer has a percentage of void space of from about 75% to about 95%.

Embodiment 40. The composition of any one of embodiments 1-39, wherein the outer layer has a percentage of void space of about 80%.

Embodiment 41. The composition of any one of embodiments 1-40, wherein when the outer layer is placed on a surface, the outer layer forms an angle between the surface and a line tangent to the edge of the outer layer of from about 90° to about 180°.

Embodiment 42. The composition of any one of embodiments 1-41, wherein when the outer layer is placed on a surface, the outer layer forms an angle between the surface and a line tangent to the edge of the outer layer of about 130°.

Embodiment 43. The composition of any one of embodiments 1-42, wherein the outer layer has a tensile strength of at least about 2 MPa.

Embodiment 44. The composition of any one of embodiments 1-43, wherein the outer layer has a tensile strength of at least about 3.5 MPa.

Embodiment 45. The composition of any one of embodiments 1-44, wherein the outer layer has a tensile strength of at least about 3.8 MPa.

Embodiment 46. The composition of any one of embodiments 1-45, wherein the outer layer has a Young's modulus of at least about 70 MPa.

Embodiment 47. The composition of any one of embodiments 1-46, wherein the outer layer has a Young's modulus of at least about 75 MPa.

Embodiment 48. The composition of any one of embodiments 1-47, wherein the outer layer has a Young's modulus of at least about 79 MPa.

Embodiment 49. The composition of any one of embodiments 1-48, wherein the entire outer surface of the inner layer is in continuous contact with the inner surface of the outer layer.

Embodiment 50. A system comprising a plurality of independent fibers, wherein each fiber is independently in fluid communication with a common fluid manifold, wherein each fiber independently comprises: a) an inner layer, wherein the inner layer comprises a fluoropolymer, wherein the inner layer has a tubular shape, wherein the inner layer further comprises an inner surface and an outer surface; and b) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber, wherein each fiber is independently configured to remove an impurity from a fluid sample as the fluid sample passes through the fiber from the common fluid manifold.

Embodiment 51. The system of embodiment 50, wherein the impurity is a salt.

Embodiment 52. The system of embodiment 50, wherein the impurity is a mineral.

Embodiment 53. The system of embodiment 50, wherein the impurity is NaCl.

Embodiment 54. The system of any one of embodiments 50-53, wherein the fluid sample is a water sample.

Embodiment 55. The system of embodiment 54, wherein the water sample is obtained from an underground water formation.

Embodiment 56. The system of any one of embodiments 50-55, wherein the fluid sample has a salinity of at least about 35,000 mg/L.

Embodiment 57. The system of any one of embodiments 50-56, wherein the fluid sample has a salinity of at least about 50,000 mg/L.

Embodiment 58. The system of any one of embodiments 50-57, wherein the fluid sample has a salinity of at least about 100,000 mg/L.

Embodiment 59. The system of any one of embodiments 50-58, wherein the fluid sample has a salinity of at least about 150,000 mg/L.

Embodiment 60. The system of any one of embodiments 50-59, wherein the fluid sample has a salinity of at least about 200,000 mg/L.

Embodiment 61. The system of any one of embodiments 50-60, wherein the fluid sample has a salinity of at least about 280,000 mg/L.

Embodiment 62. The system of embodiment 50, wherein the fluid sample is an atmospheric sample.

Embodiment 63. The system of embodiment 50, wherein the impurity is carbon dioxide.

Embodiment 64. The system of any one of embodiments 50-63, wherein the fiber further comprises a first end and a second end, wherein the first end is an inlet and the second end is an outlet, wherein the inlet is configured to allow passage of a fluid into the tubular channel, and the outlet is configured to allow passage of the fluid out of the tubular channel.

Embodiment 65. The system of any one of embodiments 50-64, wherein the inner layer is a hollow fiber membrane.

Embodiment 66. The system of any one of embodiments 50-65, wherein the fluoropolymer is a thermoplastic fluoropolymer.

Embodiment 67. The system of any one of embodiments 50-66, wherein the fluoropolymer is polyvinylidene fluoride (PVDF).

Embodiment 68. The system of any one of embodiments 50-66, wherein the fluoropolymer is ethylene chlorotrifluoroethylene (ECTFE).

Embodiment 69. The system of any one of embodiments 50-66, wherein the fluoropolymer is perfluoroalkoxy (PFA).

Embodiment 70. The system of any one of embodiments 50-66, wherein the fluoropolymer is fluorinated ethylene propylene (FEP).

Embodiment 71. The system of any one of embodiments 50-66, wherein the inner layer further comprises polyethylene glycol (PEG).

Embodiment 72. The system of any one of embodiments 50-71, wherein the inner layer comprises about 10% (wt %) of PEG.

Embodiment 73. The system of any one of embodiments 50-71, wherein the inner layer comprises about 20% (wt %) of PEG.

Embodiment 74. The system of embodiment 71, wherein the PEG is PEG-4000.

Embodiment 75. The system of embodiment 71, wherein the PEG is PEG-6000.

Embodiment 76. The system of embodiment 71, wherein the PEG is PEG-8000.

Embodiment 77. The system of any one of embodiments 50-76, wherein the inner layer has a mean thickness of from about 50 μm to about 250 μm.

Embodiment 78. The system of any one of embodiments 50-77, wherein the inner layer has a mean thickness of about 135 μm.

Embodiment 79. The system of any one of embodiments 50-78, wherein the inner layer is porous and has a mean pore size of from about 0.15 μm to about 0.4 μm.

Embodiment 80. The system of any one of embodiments 50-79, wherein the inner layer is porous and has a mean pore size is about 0.27 μm.

Embodiment 81. The system of any one of embodiments 50-80, wherein the inner layer is porous and has a maximum pore size of from about 0.3 μm to about 0.5 μm.

Embodiment 82. The system of any one of embodiments 50-81, wherein the inner layer is porous and has a maximum pore size of about 0.4 μm.

Embodiment 83. The system of any one of embodiments 50-82, wherein the inner layer has a percentage of void space of from about 75% to about 95%.

Embodiment 84. The system of any one of embodiments 50-83, wherein the inner layer has a percentage of void space of about 80%.

Embodiment 85. The system of any one of embodiments 50-84, wherein when the inner layer is placed on a surface, the inner layer forms an angle between the surface and a line tangent to the edge of the inner layer of from about 0° to about 90°.

Embodiment 86. The system of any one of embodiments 50-85, wherein when the inner layer is placed on a surface, the inner layer forms an angle between the surface and a line tangent to the edge of the inner layer of about 47°.

Embodiment 87. The system of any one of embodiments 50-86, wherein the inner layer has a tensile strength of at least about 2 MPa.

Embodiment 88. The system of any one of embodiments 50-87, wherein the inner layer has a tensile strength of at least about 3.5 MPa.

Embodiment 89. The system of any one of embodiments 50-88, wherein the inner layer has a tensile strength of at least about 3.8 MPa.

Embodiment 90. The system of any one of embodiments 50-89, wherein the inner layer has a Young's modulus of at least about 70 MPa.

Embodiment 91. The system of any one of embodiments 50-90, wherein the inner layer has a Young's modulus of at least about 75 MPa.

Embodiment 92. The system of any one of embodiments 50-91, wherein the inner layer has a Young's modulus of at least about 79 MPa.

Embodiment 93. The system of any one of embodiments 50-92, wherein the outer layer is hydrophobic.

Embodiment 94. The system of any one of embodiments 50-93, wherein the polyvinylidene is PVDF.

Embodiment 95. The system of any one of embodiments 50-94, wherein the outer layer has a mean thickness of from about 0.1 μm to about 200 μm.

Embodiment 96. The system of any one of embodiments 50-95, wherein the outer layer has a mean thickness of about 100 μm.

Embodiment 97. The system of any one of embodiments 50-96, wherein the outer layer is porous and has a mean pore size of from about 0.15 μm to about 0.4 μm.

Embodiment 98. The system of any one of embodiments 50-97, wherein the outer layer is porous and has a mean pore size is about 0.3 μm.

Embodiment 99. The system of any one of embodiments 50-98, wherein the outer layer is porous and has a maximum pore size of from about 0.3 μm to about 0.5 μm.

Embodiment 100. The system of any one of embodiments 50-99, wherein the outer layer is porous and has a maximum pore size of about 0.4 μm.

Embodiment 101. The system of any one of embodiments 50-100, wherein the outer layer has a percentage of void space of from about 75% to about 95%.

Embodiment 102. The system of any one of embodiments 50-101, wherein the outer layer has a percentage of void space of about 80%.

Embodiment 103. The system of any one of embodiments 50-102, wherein when the outer layer is placed on a surface, the outer layer forms an angle between the surface and a line tangent to the edge of the outer layer of from about 90° to about 180°.

Embodiment 104. The system of any one of embodiments 50-103, wherein when the outer layer is placed on a surface, the outer layer forms an angle between the surface and a line tangent to the edge of the outer layer of about 130°.

Embodiment 105. The system of any one of embodiments 50-104, wherein the outer layer has a tensile strength of at least about 2 MPa.

Embodiment 106. The system of any one of embodiments 50-105, wherein the outer layer has a tensile strength of at least about 3.5 MPa.

Embodiment 107. The system of any one of embodiments 50-106, wherein the outer layer has a tensile strength of at least about 3.8 MPa.

Embodiment 108. The system of any one of embodiments 50-107, wherein the outer layer has a Young's modulus of at least about 70 MPa.

Embodiment 109. The system of any one of embodiments 50-108, wherein the outer layer has a Young's modulus of at least about 75 MPa.

Embodiment 110. The system of any one of embodiments 50-109, wherein the outer layer has a Young's modulus of at least about 79 MPa.

Embodiment 111. The system of any one of embodiments 50-110, wherein the entire outer surface of the inner layer is in continuous contact with the inner surface of the outer layer.

Embodiment 112. A method comprising contacting a fluid sample with a fiber, wherein the fiber comprises: a) an inner layer, wherein the inner layer comprises a fluoropolymer, wherein the inner layer has a tubular shape, wherein the inner layer further comprises an inner surface and an outer surface; and b) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber.

Embodiment 113. The method of embodiment 112, wherein the contacting removes an impurity from the fluid sample.

Embodiment 114. The method of embodiment 113, wherein the impurity is a salt.

Embodiment 115. The method of embodiment 113, wherein the impurity is NaCl.

Embodiment 116. The method of embodiment 113, wherein the impurity is a mineral.

Embodiment 117. The method of any one of embodiments 112-116, wherein the fluid sample is a water sample.

Embodiment 118. The method of embodiment 117, wherein the water sample is from an underground water formation.

Embodiment 119. The method of any one of embodiments 112-118, wherein prior to the contacting the fluid sample has a salinity of at least about 35,000 mg/L.

Embodiment 120. The method of any one of embodiments 112-119, wherein prior to the contacting the fluid sample has a salinity of at least about 50,000 mg/L.

Embodiment 121. The method of any one of embodiments 112-120, wherein prior to the contacting the fluid sample has a salinity of at least about 100,000 mg/L.

Embodiment 122. The method of any one of embodiments 112-121, wherein prior to the contacting the fluid sample has a salinity of at least about 150,000 mg/L.

Embodiment 123. The method of any one of embodiments 112-122, wherein prior to the contacting the fluid sample has a salinity of at least about 200,000 mg/L.

Embodiment 124. The method of any one of embodiments 112-123, wherein the contacting comprises flowing the fluid sample through the outer layer.

Embodiment 125. The method of embodiment 124, wherein the fluid sample is flowed through the outer layer with a linear velocity of from about 1 m/s to about 3 m/s.

Embodiment 126. The method of embodiment 124, wherein the fluid sample is flowed through the outer layer with a linear velocity of about 2 m/s.

Embodiment 127. The method of any one of embodiments 112-126, further comprising flowing fresh water through the tubular channel, wherein the fresh water has a salinity of from about 500 mg/L to about 10,000 mg/L.

Embodiment 128. The method of embodiment 127, wherein the fresh water is deionized water.

Embodiment 129. The method of embodiment 127, wherein the fresh water is river water.

Embodiment 130. The method of any one of embodiments 127-129, wherein the fresh water is flowed through the tubular channel with a linear velocity of from about 0.5 m/s to about 2.5 m/s.

Embodiment 131. The method of any one of embodiments 127-130, wherein the fresh water is flowed through the tubular channel with a linear velocity is about 1 m/s.

Embodiment 132. The method of embodiment 113, wherein the contacting removes at least about 95% of the impurity from the fluid sample.

Embodiment 133. The method of embodiment 113, wherein the contacting removes at least about 98% of the impurity from the fluid sample.

Embodiment 134. The method of embodiment 113, wherein the contacting removes at least about 99% of the impurity from the fluid sample.

Embodiment 135. The method of embodiment 113, wherein the contacting removes at least about 99.5% of the impurity from the fluid sample.

Embodiment 136. The method of embodiment 112, further comprising: a) flowing the fluid sample through the outer layer; and b) flowing fresh water through the tubular channel.

Embodiment 137. The method of embodiment 136, wherein the fluid sample has a fluid sample temperature, the fresh water has a fresh water temperature, and wherein the fluid sample temperature and the fresh water temperature have a difference of from at least about 10° C. to at least about 80° C.

Embodiment 138. The method of embodiment 137, wherein the fluid sample temperature and the fresh water temperature have a difference of about 20° C.

Embodiment 139. The method of embodiment 137, wherein the fluid sample temperature and the fresh water temperature have a difference of about 50° C.

Embodiment 140. The method of embodiment 137, wherein the fluid sample temperature and the fresh water temperature have a difference of about 70° C.

Embodiment 141. The method of embodiment 117, wherein the method recovers at least about 70% of water in the water sample.

Embodiment 142. The method of embodiment 117, wherein the method recovers at least about 75% of water in the water sample.

Embodiment 143. The method of embodiment 117, wherein the method recovers at least about 80% of water in the water sample.

Embodiment 144. The method of embodiment 117, wherein the method recovers at least about 85% of water in the water sample.

Embodiment 145. The method of embodiment 112, wherein the fluid sample is a gaseous sample.

Embodiment 146. The method of embodiment 112, wherein the fluid sample is atmospheric air.

Embodiment 147. The method of embodiment 113, wherein the impurity is carbon dioxide.

Embodiment 148. The method of embodiment 145, wherein the contacting comprises flowing the gaseous sample through the tubular channel.

Embodiment 149. The method of any one of embodiments 145-148, further comprising flowing a solvent through the outer layer.

Embodiment 150. The method of embodiment 149, wherein the solvent is a CO₂-philic solvent.

Embodiment 151. The method of embodiment 150, wherein the CO₂-philic solvent absorbs CO₂ from the gaseous sample.

Embodiment 152. The method of embodiment 150, wherein the CO₂-philic solvent is a soybean-based solvent.

Embodiment 153. The method of embodiment 152, wherein the soybean-based solvent comprises at least 10 amino acids or charged forms thereof.

Embodiment 154. The method of embodiment 152, wherein the soybean-based solvent comprises at least 15 amino acids or charged forms thereof.

Embodiment 155. The method of any one of embodiments 151-154, further comprising regenerating the CO₂-philic solvent by releasing CO₂ from the CO₂-philic solvent.

Embodiment 156. The method of embodiment 155, wherein the regenerating comprises treating the CO₂-philic solvent with an amount of heat suitable to expel CO₂ from the CO₂-philic solvent.

Embodiment 157. The method of embodiment 156, wherein the amount of heat is from about 80° C. to about 150° C.

Embodiment 158. The method of embodiment 155, wherein the regenerating comprises treating the CO₂-philic solvent with an amount of pressure suitable to expel CO₂ from the CO₂-philic solvent.

Embodiment 159. The method of embodiment 158, wherein the amount of pressure is from about 1 kPa to about 10 kPa.

Embodiment 160. The method of embodiment 147, wherein the method further removes an amount of nitrogen gas from the fluid sample, wherein the method removes CO₂ from the fluid sample in an amount that is at least about 500-fold greater than is the amount of nitrogen gas.

Embodiment 161. The method of embodiment 147, wherein the method further removes an amount of nitrogen gas from the fluid sample, wherein the method removes CO₂ from the fluid sample in an amount that is at least about 1,000-fold greater than is the amount of nitrogen gas.

Embodiment 162. The method of embodiment 147, wherein the method further removes an amount of oxygen gas from the fluid sample, wherein the method removes CO₂ from the fluid sample in an amount that is at least about 500-fold greater than is the amount of oxygen gas.

Embodiment 163. The method of embodiment 147 wherein the method further removes an amount of oxygen gas from the fluid sample, wherein the method removes CO₂ from the fluid sample in an amount that is at least about 1,000-fold greater than is the amount of oxygen gas.

Embodiment 164. The method of embodiment 113, wherein the contacting removes at least about 90% of the impurity from the fluid sample.

Embodiment 165. The method of embodiment 113, wherein the contacting removes at least about 95% of the impurity from the fluid sample.

Embodiment 166. The method of embodiment 113, wherein the contacting removes at least about 98% of the impurity from the fluid sample.

Embodiment 167. The method of embodiment 113, wherein the contacting removes at least about 99% of the impurity from the fluid sample.

Embodiment 168. The method of any one of embodiments 112-167, wherein the fiber further comprises a first end and a second end, wherein the first end is an inlet and the second end is an outlet, wherein the inlet is configured to allow passage of a fluid into the tubular channel, and the outlet is configured to allow passage of the fluid out of the tubular channel.

Embodiment 169. The method of any one of embodiments 112-168, wherein the inner layer is a hollow fiber membrane.

Embodiment 170. The method of any one of embodiments 112-169, wherein the fluoropolymer is a thermoplastic fluoropolymer.

Embodiment 171. The method of any one of embodiments 112-170, wherein the fluoropolymer is polyvinylidene fluoride (PVDF).

Embodiment 172. The method of any one of embodiments 112-170, wherein the fluoropolymer is ethylene chlorotrifluoroethylene (ECTFE).

Embodiment 173. The method of any one of embodiments 112-170, wherein the fluoropolymer is perfluoroalkoxy (PFA).

Embodiment 174. The method of any one of embodiments 112-170, wherein the fluoropolymer is fluorinated ethylene propylene (FEP).

Embodiment 175. The method of any one of embodiments 112-174, wherein the inner layer further comprises polyethylene glycol (PEG).

Embodiment 176. The method of any one of embodiments 112-175, wherein the inner layer comprises about 10% (wt %) of PEG.

Embodiment 177. The method of any one of embodiments 112-175, wherein the inner layer comprises about 20% (wt %) of PEG.

Embodiment 178. The method of embodiment 175, wherein the PEG is PEG-4000.

Embodiment 179. The method of embodiment 175, wherein the PEG is PEG-6000.

Embodiment 180. The method of embodiment 175, wherein the PEG is PEG-8000.

Embodiment 181. The method of any one of embodiments 112-180, wherein the inner layer has a mean thickness of from about 50 μm to about 250 μm.

Embodiment 182. The method of any one of embodiments 112-181, wherein the inner layer has a mean thickness of about 135 μm.

Embodiment 183. The method of any one of embodiments 112-182, wherein the inner layer is porous and has a mean pore size of from about 0.15 μm to about 0.4 μm.

Embodiment 184. The method of any one of embodiments 112-183, wherein the inner layer is porous and has a mean pore size is about 0.27 μm.

Embodiment 185. The method of any one of embodiments 112-184, wherein the inner layer is porous and has a maximum pore size of from about 0.3 μm to about 0.5 μm.

Embodiment 186. The method of any one of embodiments 112-185, wherein the inner layer is porous and has a maximum pore size of about 0.4 μm.

Embodiment 187. The method of any one of embodiments 112-186, wherein the inner layer has a percentage of void space of from about 75% to about 95%.

Embodiment 188. The method of any one of embodiments 112-187, wherein the inner layer has a percentage of void space of about 80%.

Embodiment 189. The method of any one of embodiments 112-188, wherein when the inner layer is placed on a surface, the inner layer forms an angle between the surface and a line tangent to the edge of the inner layer of from about 0° to about 90°.

Embodiment 190. The method of any one of embodiments 112-189, wherein when the inner layer is placed on a surface, the inner layer forms an angle between the surface and a line tangent to the edge of the inner layer of about 47°.

Embodiment 191. The method of any one of embodiments 112-190, wherein the inner layer has a tensile strength of at least about 2 MPa.

Embodiment 192. The method of any one of embodiments 112-191, wherein the inner layer has a tensile strength of at least about 3.5 MPa.

Embodiment 193. The method of any one of embodiments 112-192, wherein the inner layer has a tensile strength of at least about 3.8 MPa.

Embodiment 194. The method of any one of embodiments 112-193, wherein the inner layer has a Young's modulus of at least about 70 MPa.

Embodiment 195. The method of any one of embodiments 112-194, wherein the inner layer has a Young's modulus of at least about 75 MPa.

Embodiment 196. The method of any one of embodiments 112-196, wherein the inner layer has a Young's modulus of at least about 79 MPa.

Embodiment 197. The method of any one of embodiments 112-196, wherein the outer layer is hydrophobic.

Embodiment 198. The method of any one of embodiments 112-197, wherein the polyvinylidene is PVDF.

Embodiment 199. The method of any one of embodiments 112-198, wherein the outer layer has a mean thickness of from about 0.1 μm to about 200 μm.

Embodiment 200. The method of any one of embodiments 112-199, wherein the outer layer has a mean thickness of about 100 μm.

Embodiment 201. The method of any one of embodiments 112-200, wherein the outer layer is porous and has a mean pore size of from about 0.15 μm to about 0.4 μm.

Embodiment 202. The method of any one of embodiments 112-201, wherein the outer layer is porous and has a mean pore size is about 0.3 μm.

Embodiment 203. The method of any one of embodiments 112-202, wherein the outer layer is porous and has a maximum pore size of from about 0.3 μm to about 0.5 μm.

Embodiment 204. The method of any one of embodiments 112-203, wherein the outer layer is porous and has a maximum pore size of about 0.4 μm.

Embodiment 205. The method of any one of embodiments 112-204, wherein the outer layer has a percentage of void space of from about 75% to about 95%.

Embodiment 206. The method of any one of embodiments 112-205, wherein the outer layer has a percentage of void space of about 80%.

Embodiment 207. The method of any one of embodiments 112-206, wherein when the outer layer is placed on a surface, the outer layer forms an angle between the surface and a line tangent to the edge of the outer layer of from about 90° to about 180°.

Embodiment 208. The method of any one of embodiments 112-207, wherein when the outer layer is placed on a surface, the outer layer forms an angle between the surface and a line tangent to the edge of the outer layer of about 130°.

Embodiment 209. The method of any one of embodiments 112-208, wherein the outer layer has a tensile strength of at least about 2 MPa.

Embodiment 210. The method of any one of embodiments 209, wherein the outer layer has a tensile strength of at least about 3.5 MPa.

Embodiment 211. The method of any one of embodiments 112-210, wherein the outer layer has a tensile strength of at least about 3.8 MPa.

Embodiment 212. The method of any one of embodiments 112-211, wherein the outer layer has a Young's modulus of at least about 70 MPa.

Embodiment 213. The method of any one of embodiments 112-212, wherein the outer layer has a Young's modulus of at least about 75 MPa.

Embodiment 214. The method of any one of embodiments 112-213, wherein the outer layer has a Young's modulus of at least about 79 MPa.

Embodiment 215. The method of any one of embodiments 112-214, wherein the entire outer surface of the inner layer is in continuous contact with the inner surface of the outer layer.

Embodiment 216. A method of making a fiber, the method comprising co-extruding a first dope mixture and a second dope mixture, wherein: a) the first dope mixture comprises a first fluoropolymer, polyethylene glycol (PEG), and a solvent; and b) the second dope mixture comprises a second fluoropolymer and a crosslinking agent, wherein the fiber comprises: i) an inner layer, wherein the inner layer comprises a fluoropolymer, wherein the inner layer has a tubular shape, wherein the inner layer further comprises an inner surface and an outer surface; and ii) an outer layer, wherein the outer layer comprises crosslinked polyvinylidene, wherein the outer layer has a tubular shape, wherein the outer layer further comprises an inner surface, wherein the outer surface of the inner layer is in contact with the inner surface of the outer layer to form a tubular structure, wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber.

Embodiment 217. The method of embodiment 216, wherein the second dope mixture further comprises a second solvent.

Embodiment 218. The method of embodiment 216 or 217, wherein the second dope mixture further comprises water.

Embodiment 219. The method of any one of embodiments 216-218, wherein the second dope solution consists essentially of the second fluoropolymer, the crosslinking agent, a second solvent, and water.

Embodiment 220. The method of any one of embodiments 216-219, wherein the first fluoropolymer is a thermoplastic fluoropolymer.

Embodiment 221. The method of any one of embodiments 216-220, wherein the first fluoropolymer is polyvinylidene fluoride (PVDF).

Embodiment 222. The method of any one of embodiments 216-220, wherein the first fluoropolymer is ethylene chlorotrifluoroethylene (ECTFE).

Embodiment 223. The method of any one of embodiments 216-220, wherein the first fluoropolymer is perfluoroalkoxy (PFA).

Embodiment 224. The method of any one of embodiments 216-220, wherein the first fluoropolymer is fluorinated ethylene propylene (FEP).

Embodiment 225. The method of any one of embodiments 216-224, wherein the first fluoropolymer is present in the first dope mixture in an amount of from about 5% to about 15% (wt %).

Embodiment 226. The method of any one of embodiments 216-225, wherein the first fluoropolymer is present in the first dope mixture in an amount of about 12%.

Embodiment 227. The method of any one of embodiments 216-226, wherein the PEG is PEG-4000.

Embodiment 228. The method of any one of embodiments 216-226, wherein the PEG is PEG-6000.

Embodiment 229. The method of any one of embodiments 216-226, wherein the PEG is PEG-8000.

Embodiment 230. The method of any one of embodiments 216-229, wherein the PEG is present in the first dope mixture in an amount of from about 3% to about 12% (wt %).

Embodiment 231. The method of any one of embodiments 216-230, wherein the PEG is present in the first dope mixture in an amount of about 6%.

Embodiment 232. The method of any one of embodiments 216-231, wherein the solvent is an organic solvent.

Embodiment 233. The method of any one of embodiments 216-232, wherein the solvent is N-methyl-2-pyrrolidone (NMP).

Embodiment 234. The method of any one of embodiments 216-233, wherein the solvent is present in the first dope mixture in an amount of from about 75% to about 95% (wt %).

Embodiment 235. The method of any one of embodiments 216-234, wherein the solvent is present in the first dope mixture in an amount of about 84% (wt %).

Embodiment 236. The method of any one of embodiments 216-235, wherein the second fluoropolymer is a thermoplastic fluoropolymer.

Embodiment 237. The method of any one of embodiments 216-236, wherein the second fluoropolymer is polyvinylidene fluoride (PVDF).

Embodiment 238. The method of any one of embodiments 216-236, wherein the second fluoropolymer is ethylene chlorotrifluoroethylene (ECTFE).

Embodiment 239. The method of any one of embodiments 216-236, wherein the second fluoropolymer is perfluoroalkoxy (PFA).

Embodiment 240. The method of any one of embodiments 216-236, wherein the second fluoropolymer is fluorinated ethylene propylene (FEP).

Embodiment 241. The method of any one of embodiments 216-240, wherein the second fluoropolymer is present in the second dope solution in an amount of from about 5% to about 15% (wt %).

Embodiment 242. The method of any one of embodiments 216-241, wherein the second fluoropolymer is present in the second dope solution in an amount of about 12% (wt %).

Embodiment 243. The method of any one of embodiments 216-242, wherein the water is present in the second dope mixture in an amount of from about 0.5% to about 10% (wt %).

Embodiment 244. The method of any one of embodiments 216-243, wherein the water is present in the second dope mixture in an amount of about 2% (wt %).

Embodiment 245. The method of any one of embodiments 216-244, wherein the crosslinking agent is ammonium hydroxide.

Embodiment 246. The method of any one of embodiments 216-245, wherein the crosslinking agent is present in the second dope mixture in an amount of from about 0.5% to about 10% (wt %).

Embodiment 247. The method of any one of embodiments 216-246, wherein the crosslinking agent is present in the second dope mixture in an amount of about 2% (wt %).

Embodiment 248. The method of embodiment 217, wherein the second solvent is an organic solvent.

Embodiment 249. The method of embodiment 217, wherein the second solvent is NMP.

Embodiment 250. The method of embodiment 217, 248, or 249, wherein the second solvent is present in the second dope mixture in an amount of from about 75% to about 90% (wt %).

Embodiment 251. The method of any one of embodiments 217 or 248-250, wherein the second solvent is present in the second dope mixture in an amount of about 84% (wt %).

Embodiment 252. The method of any one of embodiments 216-251, wherein the first dope mixture and the second dope mixture are co-extruded into an external coagulant.

Embodiment 253. The method of embodiment 252, wherein the external coagulant is water.

Embodiment 254. The method of any one of embodiments 216-253, wherein the fiber further comprises a first end and a second end, wherein the first end is an inlet and the second end is an outlet, wherein the inlet is configured to allow passage of a fluid into the tubular channel, and the outlet is configured to allow passage of the fluid out of the tubular channel.

Embodiment 255. The method of any one of embodiments 216-254, wherein the inner layer is a hollow fiber membrane.

Embodiment 256. The method of any one of embodiments 216-255, wherein the fluoropolymer is a thermoplastic fluoropolymer.

Embodiment 257. The method of any one of embodiments 216-256, wherein the fluoropolymer is polyvinylidene fluoride (PVDF).

Embodiment 258. The method of any one of embodiments 216-256, wherein the fluoropolymer is ethylene chlorotrifluoroethylene (ECTFE).

Embodiment 259. The method of any one of embodiments 216-256, wherein the fluoropolymer is perfluoroalkoxy (PFA).

Embodiment 260. The method of any one of embodiments 216-256, wherein the fluoropolymer is fluorinated ethylene propylene (FEP).

Embodiment 261. The method of any one of embodiments 216-260, wherein the inner layer further comprises polyethylene glycol (PEG).

Embodiment 262. The method of any one of embodiments 216-261, wherein the inner layer comprises about 10% (wt %) of PEG.

Embodiment 263. The method of any one of embodiments 216-261, wherein the inner layer comprises about 20% (wt %) of PEG.

Embodiment 264. The method of embodiment 261, wherein the PEG is PEG-4000.

Embodiment 265. The method of embodiment 261, wherein the PEG is PEG-6000.

Embodiment 266. The method of embodiment 261, wherein the PEG is PEG-8000.

Embodiment 267. The method of any one of embodiments 216-266, wherein the inner layer has a mean thickness of from about 50 μm to about 250 μm.

Embodiment 268. The method of any one of embodiments 216-267, wherein the inner layer has a mean thickness of about 135 μm.

Embodiment 269. The method of any one of embodiments 216-268, wherein the inner layer is porous and has a mean pore size of from about 0.15 μm to about 0.4 μm.

Embodiment 270. The method of any one of embodiments 216-269, wherein the inner layer is porous and has a mean pore size is about 0.27 μm.

Embodiment 271. The method of any one of embodiments 216-270, wherein the inner layer is porous and has a maximum pore size of from about 0.3 μm to about 0.5 μm.

Embodiment 272. The method of any one of embodiments 216-271, wherein the inner layer is porous and has a maximum pore size of about 0.4 μm.

Embodiment 273. The method of any one of embodiments 216-272, wherein the inner layer has a percentage of void space of from about 75% to about 95%.

Embodiment 274. The method of any one of embodiments 216-273, wherein the inner layer has a percentage of void space of about 80%.

Embodiment 275. The method of any one of embodiments 216-274, wherein when the inner layer is placed on a surface, the inner layer forms an angle between the surface and a line tangent to the edge of the inner layer of from about 0° to about 90°.

Embodiment 276. The method of any one of embodiments 216-275, wherein when the inner layer is placed on a surface, the inner layer forms an angle between the surface and a line tangent to the edge of the inner layer of about 47°.

Embodiment 277. The method of any one of embodiments 216-276, wherein the inner layer has a tensile strength of at least about 2 MPa.

Embodiment 278. The method of any one of embodiments 216-277, wherein the inner layer has a tensile strength of at least about 3.5 MPa.

Embodiment 279. The method of any one of embodiments 216-278, wherein the inner layer has a tensile strength of at least about 3.8 MPa.

Embodiment 280. The method of any one of embodiments 216-279, wherein the inner layer has a Young's modulus of at least about 70 MPa.

Embodiment 281. The method of any one of embodiments 216-280, wherein the inner layer has a Young's modulus of at least about 75 MPa.

Embodiment 282. The method of any one of embodiments 216-281, wherein the inner layer has a Young's modulus of at least about 79 MPa.

Embodiment 283. The method of any one of embodiments 216-282, wherein the outer layer is hydrophobic.

Embodiment 284. The method of any one of embodiments 216-283, wherein the polyvinylidene is PVDF.

Embodiment 285. The method of any one of embodiments 216-284, wherein the outer layer has a mean thickness of from about 0.1 μm to about 200 μm.

Embodiment 286. The method of any one of embodiments 216-285, wherein the outer layer has a mean thickness of about 100 μm.

Embodiment 287. The method of any one of embodiments 216-286, wherein the outer layer is porous and has a mean pore size of from about 0.15 μm to about 0.4 μm.

Embodiment 288. The method of any one of embodiments 216-287, wherein the outer layer is porous and has a mean pore size is about 0.3 μm.

Embodiment 289. The method of any one of embodiments 216-288, wherein the outer layer is porous and has a maximum pore size of from about 0.3 μm to about 0.5 μm.

Embodiment 290. The method of any one of embodiments 216-289, wherein the outer layer is porous and has a maximum pore size of about 0.4 μm.

Embodiment 291. The method of any one of embodiments 216-290, wherein the outer layer has a percentage of void space of from about 75% to about 95%.

Embodiment 292. The method of any one of embodiments 216-291, wherein the outer layer has a percentage of void space of about 80%.

Embodiment 293. The method of any one of embodiments 216-292, wherein when the outer layer is placed on a surface, the outer layer forms an angle between the surface and a line tangent to the edge of the outer layer of from about 90° to about 180°.

Embodiment 294. The method of any one of embodiments 216-293, wherein when the outer layer is placed on a surface, the outer layer forms an angle between the surface and a line tangent to the edge of the outer layer of about 130°.

Embodiment 295. The method of any one of embodiments 216-294, wherein the outer layer has a tensile strength of at least about 2 MPa.

Embodiment 296. The method of any one of embodiments 216-295, wherein the outer layer has a tensile strength of at least about 3.5 MPa.

Embodiment 297. The method of any one of embodiments 216-296, wherein the outer layer has a tensile strength of at least about 3.8 MPa.

Embodiment 298. The method of any one of embodiments 216-297, wherein the outer layer has a Young's modulus of at least about 70 MPa.

Embodiment 299. The method of any one of embodiments 216-298, wherein the outer layer has a Young's modulus of at least about 75 MPa.

Embodiment 300. The method of any one of embodiments 216-299, wherein the outer layer has a Young's modulus of at least about 79 MPa.

Embodiment 301. The method of any one of embodiments 216-300, wherein the entire outer surface of the inner layer is in continuous contact with the inner surface of the outer layer.

1-110. (canceled)

112. A method comprising contacting a fluid sample with a fiber, wherein the fiber comprises:
a) an inner layer, wherein the inner layer comprises a fluoropolymer, wherein the inner layer has a tubular shape, wherein the inner layer further comprises an inner surface and an outer surface; and
b) an outer layer, wherein the outer layer comprises crosslinked polyvinylidene, wherein the outer layer has a tubular shape, wherein the outer layer further comprises an inner surface,
wherein the outer surface of the inner layer is in contact with the inner surface of the outer layer to form a tubular structure,
wherein in the tubular structure, the tubular shape of the inner layer is inside the tubular shape of the outer layer with the tubular shape of the inner layer oriented in a common direction with the tubular shape of the outer layer, and wherein the inner surface of the inner layer forms a tubular channel through the fiber.

113. The method of claim 112, wherein the contacting removes an impurity from the fluid sample.

114. The method of claim 113, wherein the impurity is a salt.

115-116. (canceled)

117. The method of claim 112, wherein the fluid sample is a water sample.

118. (canceled)

119. The method of claim 112, wherein prior to the contacting the fluid sample has a salinity of at least about 35,000 mg/L.

120-123. (canceled)

124. The method of claim 112, wherein the contacting comprises flowing the fluid sample through the outer layer.

125. The method of claim 124, wherein the fluid sample is flowed through the outer layer with a linear velocity of from about 1 m/s to about 3 m/s.

126. (canceled)

127. The method of claim 112, further comprising flowing fresh water through the tubular channel, wherein the fresh water has a salinity of from about 500 mg/L to about 10,000 mg/L.

128-129. (canceled)

130. The method of claim 127, wherein the fresh water is flowed through the tubular channel with a linear velocity of from about 0.5 m/s to about 2.5 m/s.

131-132. (canceled)

133. The method of claim 113, wherein the contacting removes at least about 98% of the impurity from the fluid sample.

134-135. (canceled)

136. The method of claim 112, further comprising:
a) flowing the fluid sample through the outer layer; and
b) flowing fresh water through the tubular channel.

137. The method of claim 136, wherein the fluid sample has a fluid sample temperature, the fresh water has a fresh water temperature, and wherein the fluid sample temperature and the fresh water temperature have a difference of from at least about 10° C. to at least about 80° C.

138-140. (canceled)

141. The method of claim 117, wherein the method recovers at least about 70% of water in the water sample.

142-167. (canceled)

168. The method of claim 112, wherein the fiber further comprises a first end and a second end, wherein the first end is an inlet and the second end is an outlet, wherein the inlet is configured to allow passage of a fluid into the tubular channel, and the outlet is configured to allow passage of the fluid out of the tubular channel.

169. The method of claim 112, wherein the inner layer is a hollow fiber membrane.

170. (canceled)

171. The method of claim 112, wherein the fluoropolymer is polyvinylidene fluoride (PVDF).

172-174. (canceled)

175. The method of claim 112, wherein the inner layer further comprises polyethylene glycol (PEG).

176-180. (canceled)

181. The method of claim 112, wherein the inner layer has a mean thickness of from about 50 μm to about 250 μm.

182. (canceled)

183. The method of claim 112, wherein the inner layer is porous and has a mean pore size of from about 0.15 μm to about 0.4 μm.

184-186. (canceled)

187. The method of claim 112, wherein the inner layer has a percentage of void space of from about 75% to about 95%.

188-196. (canceled)

197. The method of claim 112, wherein the outer layer is hydrophobic.

198. The method of claim 112, wherein the polyvinylidene is PVDF.

199-200. (canceled)

201. The method of claim 112, wherein the outer layer is porous and has a mean pore size of from about 0.15 μm to about 0.4 μm.

202-301. (canceled)
